(19) United States
(12) Patent Application Publication
(10) Pub. No.: US 2005/0195221 A1
(43) Pub. Date: Sep. 8, 2005

(54) System and method for facilitating the presentation of content via device displays

(76) Inventors: Adam Berger, Pittsburgh, PA (US); Thomas Kang, Pittsburgh, PA (US); Tony Dewitt, Pittsburgh, PA (US); Gregory C. Schohn, Brooklyn, NY (US)

Correspondence Address: CRAWFORD MAUNU PLLC, 1270 NORTHLAND DRIVE, SUITE 390, ST. PAUL, MN, 55120, US

(21) Appl. No.: 10/793,426

(22) Filed: Mar. 4, 2004

(51) Int. Cl. G06K 9/00

(52) U.S. Cl. 345/660

(57) ABSTRACT

A system, apparatus, and method for facilitating presentation of content on communication device displays. A side-by-side or other adjacent display presentation allows content to be viewed in both a thumbnail view and a reformatted enhanced view. Content is converted to a raster image which is in turn segmented, either automatically or involving user guidance, to create a segmented raster image. Resulting segments may be selected for viewing in the enhanced viewing mode, such as an enlarged, reformatted presentation to allow the targeted region to be more easily viewed and/or to require fewer user interface manipulations. Regions can be labeled for simple and efficient selection of targeted regions.

### FIELD OF THE INVENTION

This invention relates in general to displaying content, and more particularly to a system, method and apparatus for facilitating the presentation of content on communication device displays.

### BACKGROUND OF THE INVENTION

Both landline and wireless computing systems are presently capable of receiving information in a variety of content types and formats, from a variety of different sources including networked sources. Landline systems, such as desktop computers, workstations, terminals, etc. generally utilize commercially-available Web browsers in order to interact with various kinds of Internet resources. This type of browser is generally a software program stored locally at the client device. In the Internet context, web content created with Hypertext Markup Language (HTML) or other language can be read by such Web browsers. Analogous technologies exist for communicating landline content via wireless devices.

Content from the Internet or other network sources are increasingly being consumed on smaller devices, such as mobile phones, Personal Digital Assistants (PDAs), laptop computers and the like. For example, the popularity and resulting proliferation of these portable and/or hand-held wireless devices has fueled the need to make Internet web pages and other content available to mobile device users. However, there are various factors that limit a user's ability efficiently utilize Internet content on mobile devices. One such factor is the relatively limited display capabilities on mobile devices, due to the limited display screen size.

The small displays and reduced usability of mobile devices make the consumption of Internet content challenging, as Internet content is typically designed and formatted for consumption on desktop or other landline platforms used with high-resolution displays and advanced input capabilities. One manner for addressing this mismatch in display capabilities is the use of a narrow-screen layout. A system implementing a narrow-screen layout reformats content to fit the width of the device display, adapting or removing tabular information, frames, multicolumn text, and other two-dimensional formatting directives as necessary. The system will shrink large images down to the width of the screen. One benefit of a narrow-mode rendering is the ease of navigation, as no horizontal panning is required. However, this mode suffers from a problem that may be referred to as ill-defined serialization. That is, the optimal or most intuitive serialization of a two-dimensional web page is not always obvious. In some cases, a meaningful projection into one dimension may not even exist. For example, it may be unclear whether cells from a two-dimensional table should be presented in row-major order or column-major order.

Another manner for presenting content on small displays is referred to as full-scale layout. In this case, the content is not reformatted, but rather is provided “as-is” to the mobile device. The user must then pan horizontally and vertically to view the document in its entirety, similar to that which a desktop user experiences when viewing a particularly wide web page. Full-scale rendering does not suffer from the problems associated with re-formatted content. However, latency can be an issue as computing a rendering of a full-scale web page is non-trivial, and generally involves multiple passes to resolve the positioning of images and table elements. In fact, when accessing a typical complex web page on a mobile device, the rendering computation is the primary bottleneck—much more than the latency induced by cellular data networks.

Both narrow-screen and full-scale rendering modes share another problem, which may be referred to as the user-disorientation problem. Specifically, users often lose track of their position while navigating through web content. Also, it is difficult for the user to determine where in a document the navigation is heading, as well as how to return to a previous location in the document.

A new proposed user interface for mobile web browsing, referred to herein as a “minipage,” is also designed to compensate for small mobile device displays. The system generates a raster (minipage) image of a web page retrieved via a browser, where the raster image is scaled to fit the dimensions of the device's display. The web page is divided into visually discrete regions, referred to as segmentation. However, for a given web page there may be many possible segmentations, yet a particular one of these segmentation possibilities will be imposed upon each user.

Notwithstanding the potentially poor quality of a segmentation, the user may select a segment to view. This is typically performed using a mouse, graphics tablet, stylus, data glove, or other random-access selector. Interacting with a minipage can be difficult where the mobile device is not equipped with a random-access selector, and may still be inconvenient where such a selector is available. Mouse and pointing devices can be cumbersome to use on mobile devices, and in many cases are not even available on the device.

As indicated above, there are various shortcomings with conventional browsing methodologies, particularly in the wireless/mobile device arena. To maximize the intended benefit of technological advances in networking infrastructures and protocols, more suitable content presentation mechanisms and methodologies are required to address the various device characteristics and diverse needs of the content-consuming public.

Accordingly, a need exists to facilitate the presentation of content such as web pages or other documents on device displays that are smaller than the size to which the content was designed. For example, it would be desirable to provide a manner in which mobile device users can more readily identify desired portions of a retrieved web page for viewing, where these identified portions are presented such that they are easily viewable by the device user. Further, a need exists to generally aid user interaction with such browser content, whether viewed via a small mobile device display or a standard computer display. The present invention addresses these problems and shortcomings of the prior art, and offers a variety of benefits and advantages over conventional browsing techniques.

### SUMMARY OF THE INVENTION

To overcome limitations in the prior art described above, and to overcome other limitations that will become apparent upon reading and understanding the present specification, the present invention discloses a system, apparatus and method for facilitating the presentation of content on communication device displays.

In accordance with one embodiment of the invention, a method is provided for presenting content on a display of a communication device. The communication device may be any electronic/computing device at least capable of receiving information (e.g., documents, web pages, or other content) over a network. The method includes dividing a raster image (or equivalent) of the content into regions or segments to create a segmented image, and presenting the segmented image in a first portion of the display. The method further involves facilitating selection of a segment(s) of the segmented image, and presenting a visually enhanced view, such as by way of a narrow-screen layout, of the selected segment in a second portion of the display. The “display” of the communication device includes a single display element having at least first and second presentation areas, as well as a display having multiple display units (e.g., side-by-side display screens).

According to more particular embodiments of such a method, the user may be allowed to select the segment via a user interface on the communication device. Alternatively, the segment may be automatically selected based on predetermined criteria, such as a location within the raster image, the category/heading associated with the regions, etc. For example, the segmented region at the top left corner of the raster image may be automatically selected when the user initiates viewing the content, which can then be automatically presented in the second portion of the display. As another example, the segmented region associated with a particular category or heading may be automatically selected, such as a “main content,” “top stories,” or other designated category. Again, the automatically selected region(s) may be automatically presented in the second portion of the display, so that the user is presented with a default region to view in the second portion of the display upon initiating viewing of the content.

According to additional particular embodiments of such a method, presenting the segmented image may involve presenting the segmented image at a first side panel of the display, and presenting the visually enhanced view of the selected segment in a second side panel horizontally adjacent to the first side panel. To assist the device user, the selected segment in the first display portion may be distinguished from the non-selected segments, such as through the use of symbol overlays, region highlighting, region coloring, region grey-scaling, region border highlighting, region border coloring, region border grey-scaling, region border line widths, etc.

Still other embodiments of such a method involve the ability to present new information through selection of a link in the segment that is currently displayed via the second display panel. More particularly, the user may be viewing a selected segment in the second display panel, click on or otherwise activate a link associated with the content displayed via the second display panel, which causes new content to be loaded, and causes a raster image of this new content to be presented in the first display panel from which a segment may be manually or automatically selected. In a more particular embodiment, this involves facilitating selection of a link presented on the second portion of the display, creating a raster image of the new document, dividing this second raster image into segments to create a segmented image, presenting this new segmented image in the first display portion, manually or automatically selecting a resulting segment(s), and presenting a visually enhanced view of the resulting segment in the second display portion. In another embodiment involving the presentation of new information in the second display panel, the method may further include presenting an adjacent segment in the second portion of the display when the selected segment has been scrolled beyond its border in the second portion of the display. In such case, the adjacent segment represents the segment in the segmented image that borders the selected segment in the direction that the user scrolled.

In accordance with another embodiment of the invention, a communication device is provided that includes at least a display, a transceiver to transmit requests for content and to receive the content in response, and a processor. The processor is configured (e.g., with software, firmware, etc.) to present a segmented raster image of the content in a first area of the display, and to recognize a selected segment(s) from the segmented raster image. The processor is further configured to present a visually enhanced view of the selected segment(s) in a second area of the display. The communication device may be any device capable of receiving information from an external source, such as a mobile phone, Personal Digital Assistant (PDA), portable computer, desktop computer, or the like.

In accordance with another embodiment of the invention, a method is provided for presenting content on a display of a communication device. The method includes presenting a segmented raster image of the content on the display, where the segmented raster image includes multiple regions/segments. Unique labels are respectively correlated with at least some of the segments, and are each presented together with its associated segment. User input of a label(s) is recognized in order to identify the segment associated with the label designated by the user. A visually enhanced view of the identified segment, such as by way of a narrow-screen layout, is then presented on the display.

According to more particular embodiments of such a method, the unique labels may be continuously presented, such as by superimposing the labels on their respective segments. The labels may be presented as opaque labels, or may be semi-transparent as in the case of alpha-blending. Alternatively, the presentation of the labels may be temporary, and in some cases may be presented “on-demand” such as in the case of hot-toggling.

According to yet other embodiments of the invention, hierarchical labeling may be implemented, such that identification of a region label presents additional labels on the “subsegments” of the selected segment. More particularly, one embodiment involves respectively correlating second unique labels with at least some of the subsegments associated with a particular segment, presenting each of the second unique labels together with its respective subsegments, recognizing user input of a second unique label(s), identifying the subsegment associated with the second unique label input by the user, and presenting a visually enhanced view of the identified subsegment on the display. This hierarchical selection process may repeat until the user is content with the hierarchical level currently presented, until no further hierarchical descendants are available, or until any other predetermined event occurs.

In accordance with another embodiment of the invention, a communication device is provided that includes at least a display, a user interface, a transceiver to transmit requests for content and to receive the content, and a processor. The processor is configured to present a segmented raster image of the content via the display, and to respectively correlate unique labels with each of the segments associated with the segmented raster image. The processor is further configured to present each of the unique labels together with its associated segment, and to recognize user input of a unique label(s) via the user interface. The processor configuration further involves identifying the segment associated with the unique label input by the user, and presenting a visually enhanced view of the identified segment on the display. The communication device may be any device capable of receiving information from an external source, such as a mobile phone, PDA, portable computer, desktop computer, or the like.

In accordance with another embodiment of the invention, a method is provided for preparing content for viewing on a communication device display. The method includes presenting a raster image of the content on the communication device display, and facilitating user demarcation of a region(s) on the raster image. The raster image is then segmented into a plurality of segments, where at least one of the segments substantially corresponds to the region(s) demarcated by the user. The segment(s) identified by the user, and/or other ones of the segments may then be presented via the communication device display, such as (for example) via a narrow-screen layout.

According to more particular embodiments of such a method, facilitating user demarcation of a region(s) on the raster image may involve recognizing user input via a user interface (UI) that visually demarcates the region(s) on the raster image. Further, the user may be enabled to demarcate multiple regions on the raster image, and to discontinue further user demarcation of the regions (e.g., “finished” UI function).

According to still other particular embodiments, a nearest probable segment boundary for each region demarcated by the user may be determined. In this manner, the demarcated region(s) may be adjusted to coincide with its respective nearest probable segment boundary. One manner in which this may be accomplished is through a “snapping” function.

According to yet another particular embodiment, a learning feature may be implemented, to allow previous segmentations of a particular document, web page, or other content to be stored and later retrieved when that document/page/content is again requested or otherwise accessed. For example, the method may involve associating previous user-demarcated regions with their corresponding content addresses, storing the association of the previous user-demarcated regions and the corresponding content addresses, and comparing a currently-received content address with the stored content addresses. Segmenting then involves segmenting the raster image of the currently-received content using the stored user-demarcated regions associated with the content address.

In accordance with another embodiment of the invention, a communication device is provided that includes at least a display, a user interface, a transceiver to transmit requests and to receive content, and a processor. The processor is configured to present a raster image of the content on the communication device display, and to further recognize user input identifying a region(s) on the raster image. The processor is configured to divide the raster image into a plurality of segments, where at least one of the plurality of segments substantially corresponds to the region(s) identified by the user. The communication device may be any device capable of receiving information from an external source, such as a mobile phone, PDA, portable computer, desktop computer, or the like.

These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described specific examples of a system, apparatus, and method in accordance with the invention.

### BRIEF DESCRIPTION OF THE DRAWINGS

The invention is described in connection with the embodiments illustrated in the following diagrams.

FIG. 1A illustrates representative examples in which content may be presented to devices having a display size that is smaller than the dimensions to which the content was created;

FIG. 1B is a block diagram illustrating a representative system in which the principles of the present invention may be employed;

FIG. 2 is a block diagram illustrating one embodiment of the present invention involving a user-guided segmentation process;

FIG. 3 is a block diagram illustrating a representative embodiment for allowing user contributions to the creation of an initial page segmentation in accordance with the present invention;

FIGS. 4A and 4B illustrate representative manners for snapping imprecise user-designated region boundaries to nearby logical boundaries;

FIGS. 5A-5F illustrate various representative manners in which regions may be designated by a device user;

FIG. 6 illustrates a manner for facilitating user designation of non-rectangular or other non-standard regions during a user-guided segmentation process;

FIG. 7 illustrates a representative manner of editing a segmentation in accordance with the present invention;

FIG. 8 is a block diagram illustrating an exemplary system for performing user-guided segmentation in accordance with the present invention;

FIGS. 9 and 10A are flow diagrams illustrating various embodiments of methods for facilitating viewing of a page/document on a device display;

FIG. 10B depicts a representative Document Object Model (DOM) and corresponding frame tree for assisting in identifying regions for raster image partitioning;

FIG. 11A is a block diagram illustrating an exemplary embodiment of segment labeling using alpha-blended labels in accordance with the present invention;

FIG. 11B is a block diagram illustrating an exemplary embodiment of segment labeling using hot-toggling in accordance with the present invention;

FIG. 12 illustrates an example of hierarchical labeling in accordance with one embodiment of the invention;

FIG. 13 is a flow diagram illustrating a method for executing hierarchical labeling in accordance with one embodiment of the present invention;

FIGS. 14A and 14B illustrate representative embodiments of split-screen viewing displays in accordance with the present invention;

FIG. 14C illustrates a representative manner for conserving computation resources when performing raster image rendering in accordance with the invention;

FIG. 15 is a flow diagram illustrating one embodiment for presenting a web page or other document using a split-screen methodology in accordance with the present invention; and

FIG. 16 illustrates representative networked system in which the present invention may be implemented.

### DETAILED DESCRIPTION OF THE INVENTION

In the following description of various exemplary embodiments, reference is made to the accompanying drawings which form a part hereof, and in which is shown by way of illustration various embodiments in which the invention may be practiced. It is to be understood that other embodiments may be utilized, as structural and operational changes may be made without departing from the scope of the present invention.

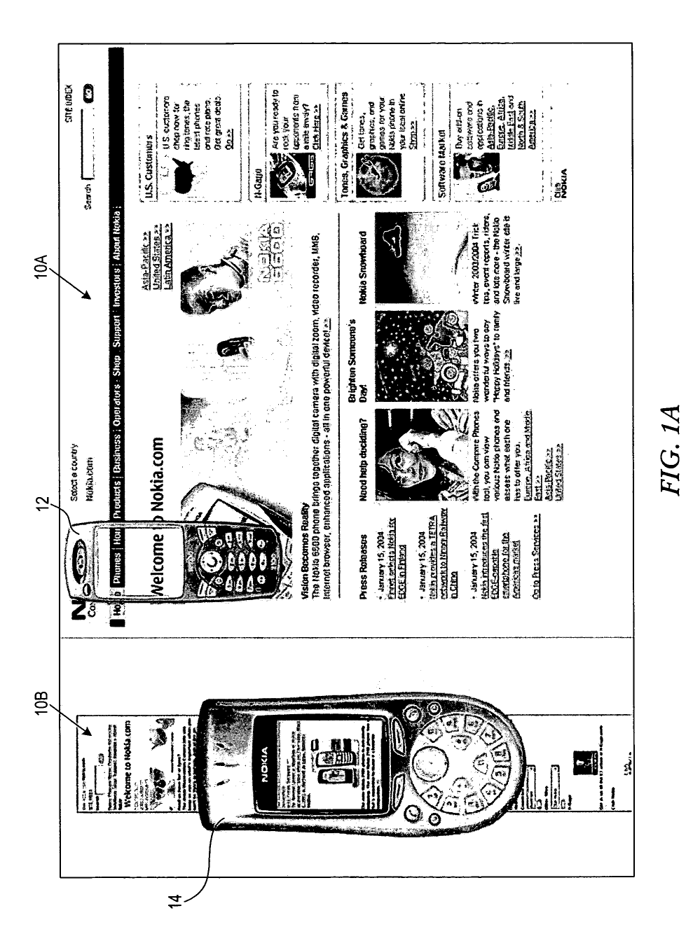

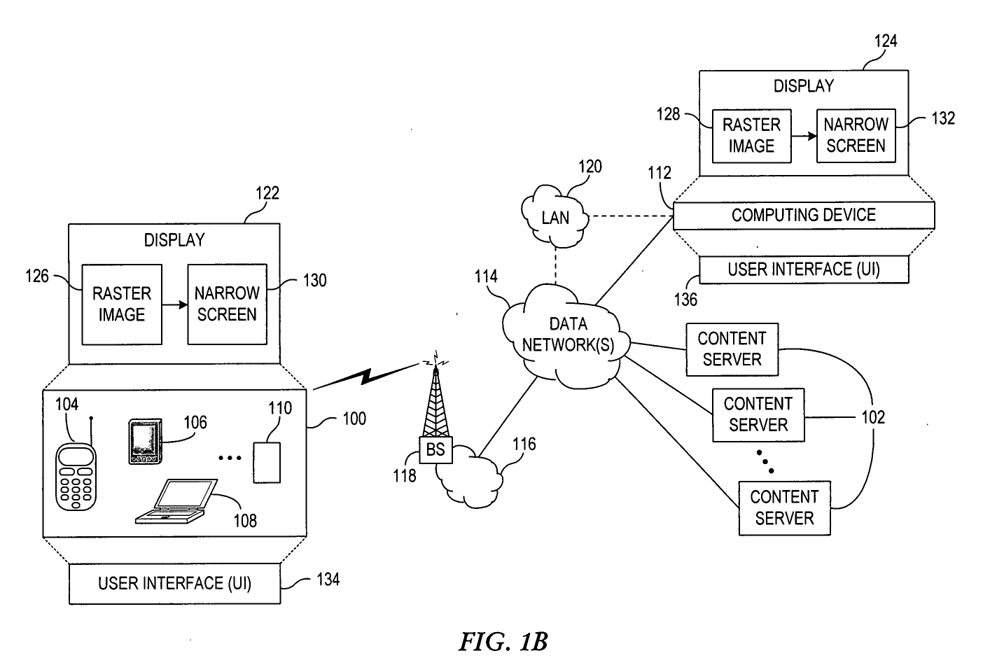

As previously indicated, properly presenting content on device display screens can be difficult, particularly in the case of mobile devices where small displays are necessitated by the inherent small size of such devices. While such difficulties may be presented for content associated with local applications and data, such local applications are generally designed to properly present information on the device display associated with that particular device. However, other content is often created for use and presentation on a device having a particular set of display capabilities, but it would be desirable to allow use and presentation of that content on a device having different display capabilities. Content available on the Internet or other data networks is an example of such content. This content is often created for display on desktop or laptop computers having a relatively large display device. When such content is viewed via a mobile device display, or other wireless or landline device having a display size smaller than that intended for the content, the user is often required to scroll horizontally and vertically to view the content. This is illustrated in FIG. 1A, where a full-scale version 10A of the web page is illustrated. This version offers complete fidelity to the original web page layout, but requires the user of the mobile device 12 to engage in both up-down scrolling and left-right panning to view the entire document. This is burdensome to the user, and can make functions such as Internet access via mobile devices less desirable for mobile users.

Another solution is to reformat the original content so that horizontal scrolling is not required. This is illustrated in FIG. 1A by the narrow-screen layout 10B of the web page. In this case, the original document has been reformatted into a linear or “ticker-tape” form, which only requires the user of the mobile device 14 to scroll in the up-down directions. The narrow-screen layout 10B also has shortcomings, in that it is difficult for the user to know where within the page he/she is currently viewing.

The present invention addresses these and other problems associated with the presentation of information on device displays that are smaller than the display size to which the content was originally created and/or intended. Generally, the present invention provides a manner for facilitating presentation of content on communication device displays. The invention addresses limited display screen problems by providing a multi-screen view of raster images of web pages/documents and currently-active regions of the raster images. Further, when a device user requests a web page, document, or other content via a network, the requested content is converted to a raster image, such as a thumbnail or “imagemap.” The image is segmented, which in some embodiments is partially or entirely guided by user actions. In other embodiments, the segmentation is performed automatically. The resulting segments or regions may be selected for viewing in an enhanced viewing mode, such as an enlarged, reformatted presentation to allow the targeted region to be more easily viewed and/or to require fewer user interface manipulations. Regions can be labeled for simple and efficient selection of targeted regions. These and other benefits provided by the invention are described more fully in the ensuing description.

It should be recognized that the use of the term “raster image” as used herein is intended to include any type of overview, thumbnail, imagemap, document map, or other image or vector-based representation that is generated to be a smaller size than its original counterpart, and may be processed and segmented as described herein. As such, these various terms are used interchangeably in the description. The invention is intended to contemplate any such image regardless of the underlying technology involved.

FIG. 1B is a block diagram illustrating a representative system in which the principles of the present invention may be employed. Mobile (e.g., wireless) communication devices 100 may seek access to content or other information provided by various content servers 102 provided by way of one or more networks. These mobile devices 100 may include any communication device capable of engaging in wireless communication, such as mobile phones 104, Personal Digital Assistants (PDA) 106, portable computing devices 108 such as laptop or notebook computers, or any other device 110 capable of networked over-the-air (OTA) communication. Other computing/communication devices 112, such as desktop or other landline computers, may also seek access to content provided by the various content servers 102.

In the illustrated embodiment, the content servers 102 are accessible via one or more data networks 114 including, but not limited to, the Internet. Mobile devices 100 can access such data networks 114 via cellular networks 116 or other mobile networks. For example, cellular network 116 includes base stations (BS) 118, each of which serves as a wireless access point for mobile devices 100 within the cell served by that base station 118. Such mobile networks 116 can communicate with data networks 114 to access information stored on devices such as the content servers 102. In this manner, the mobile devices 100 can access information, such as web content, from the content servers 102. Other computing/communication devices, such as computing device 112, can access the information from content servers 102 through direct communication via the data networks 114, and/or via local area networks (LAN) such as LAN 120.

Such devices 100, 112 may have display devices 122, 124 that are smaller than an optimal display size to properly view accessed content without undue scrolling, particularly horizontal scrolling, or other panning/viewing manipulations. The present invention facilitates the presentation of relevant information and content on such “narrow screen” devices. For example, embodiments of the present invention include presentation and/or involvement of a raster image 126, 128 from which a narrow screen 130, 132 presentation may be derived. The mobile device 100 or other computing device 112 may include a user interface (UI) 134, 136, which in accordance with some embodiments facilitates the narrow screen 130, 132 derivation or other features associated with presenting content via the respective display 122, 124 as described more fully below. It should be noted that while many embodiments of the present invention are described in terms of displaying information via mobile device displays, the present invention is equally applicable to other communication devices, including desktop computing devices or other computing/communication devices having a display size insufficient to readily view certain information accessed by the respective device. Further, the invention is even applicable where sufficiently large displays are used where the content will typically fit, yet other factors may call for viewing enhancements in accordance with the invention. One such example is to provide enhanced viewing capabilities for the visually impaired, an embodiment of which is described in greater detail in the ensuing description.

A visual user interface for mobile web browsing may involve the concept of a “minipage,” which compensates for small screen sizes of mobile devices. A raster minipage image of the original web page(s) is generated and scaled to fit the dimensions of the device's display. The system divides the raster image into discrete segments or regions that can be selected by moving a cursor or selector to the desired segment and selecting it, or by other manners such as entering an index number for the particular region. The display is changed such that the raster image is then replaced by the selected segment which can be presented such that limited or no horizontal scrolling is required. It is noted that the terms “region” and “segment” may be used interchangeably herein. Further, the information obtained for viewing on the communication device may be interchangeably referred to herein as a “page,” “document,” or “content.”

In connection with such a process, the system divides the raster image into discrete segments as described above. This process is referred to herein as “segmentation.” Current segmentation processes divide the document automatically, based on predetermined criteria. However, a typical document generally has several possible segmentations, as there are various ways to divide the same document. Different device users may prefer different segmentations of the same web pages/documents. The present invention includes a manner of allowing particular users to contribute to the segmentation decisions to arrive at a segmentation better suited to that particular user.

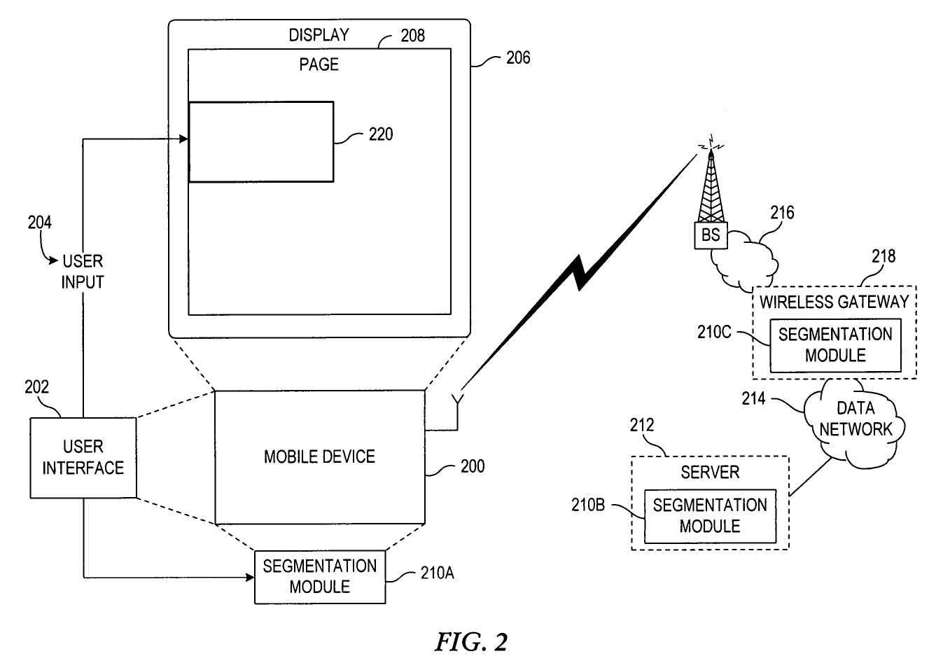

FIG. 2 is a block diagram illustrating one embodiment in which the present invention addresses the difficulty of performing proper segmentations, by including the user in the segmentation process. Thus, the user provides input to guide the segmentation process. For example, the user may be using a mobile device 200, which may be a mobile phone, PDA, portable computer, or other device capable of OTA communications. The device includes a user interface (UI) 202, allowing the user to provide user input 204 for use in the segmentation process. A display 206 is also associated with the mobile device 200, where web pages 208 or other received documents may be presented. It should be noted that the display 206 may also serve as a UI 202 mechanism, such as is the case with touch screen systems.

A segmentation module that operates to derive the appropriate page 208 segmentations is provided. The segmentation module may be hosted by the mobile device 200 (segmentation module 210A), or may be provided over the network. For example, a server 212 including segmentation module 210B may be coupled to a data network 214 such as the Internet, private network, etc. The mobile device 200 accesses the services of the web server 212 via a wireless network 216 in such cases. Alternatively, segmentation module 210C may be provided at other network elements, such as at a wireless gateway 218. Where the segmentation module 210B, 210C is situated remotely to the mobile device 200, the mobile device 200 communicates with one or more of the networks 214, 216 to provide input to, and receive information from, the appropriate segmentation module 210B, 210C. For purposes of example, it is assumed for the description of FIG. 2 that the segmentation module 210A is locally hosted by the mobile device 200. The following description also applies to situations involving remote segmentation modules 210B, 210C.

In accordance with the present invention, the user provides user input 204 via the user interface 202 to assist in the creation of a segmented page 208. This input 204 may include hinting, suggesting, or directly identifying one or more regions 220 of the page 208 to be a discernable segment(s) of a resulting segmentation. Further, the user input 204 may include editing, such that a proposed segmentation and/or a proposed region(s) of a resulting segmentation can be modified pursuant to the user's directives. Examples of these various concepts are described more fully below.

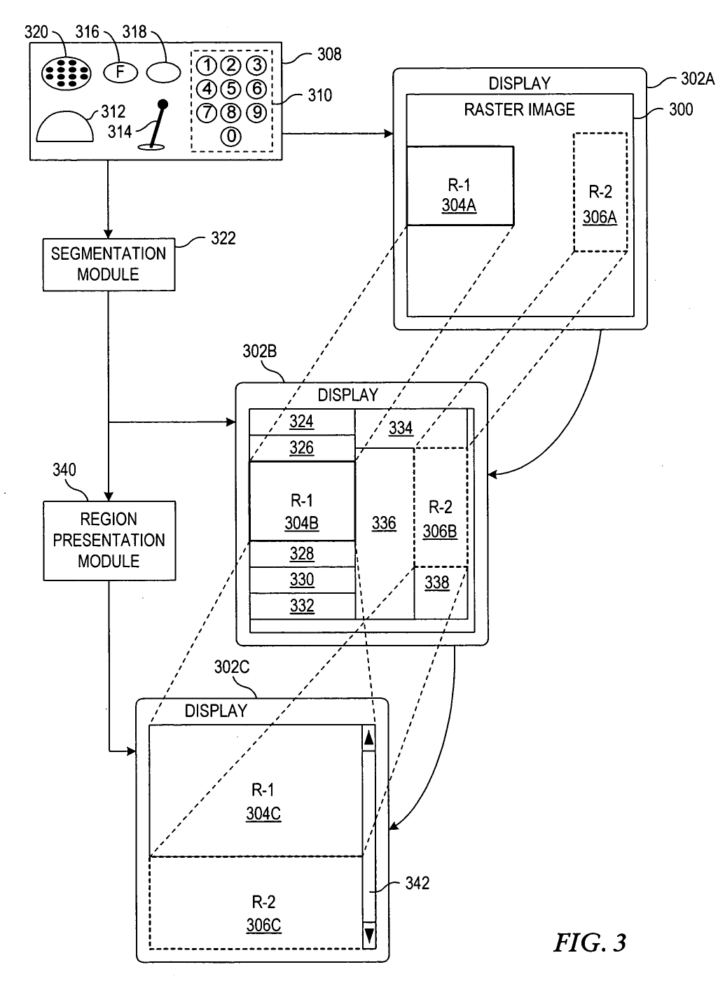

FIG. 3 is a block diagram illustrating a representative embodiment for allowing user contributions to the creation of an initial page segmentation in accordance with the present invention. In this embodiment, the user is presented with a raster image 300 of the page(s) of interest on the user's mobile device display 302A, where the raster image 300 has not yet been segmented. In accordance with the invention, the user provides some input to guide the segmentation process, which is referred to herein as the “hinting” (or suggestion) mode. In hinting mode the user provides guidance, whether definitive or suggestive, as to the manner in which one or more regions will be defined in a resulting segmentation of the raster image 300.

In a more particular example, the raster image 300 is presented on the mobile device display 302A. The raster image 300 may include all or a portion of a web page(s) requested by the user or otherwise provided to the mobile device display 302A. In accordance with one embodiment of the invention, the user identifies one or more regions, such as regions 304A and 306A, on the raster image 300 of the display via a user interface (UI) 308. Any UI mechanism may be employed to highlight or otherwise delineate the desired regions 304A, 306A for definitive or suggestive inclusion in the segmentation. These UI mechanisms may include a keypad 310, which may include alpha, numeric, alphanumeric, or other symbols used to identify the desired regions for segmentation. Other illustrative UI mechanisms include a mouse, wheel, or other scrolling mechanism 312, joystick or other directional selector 314, selection buttons 316, 318, a microphone 320 for voice command input, touch screen (not shown), or any other appropriate UI mechanism.

By way of the UI 308, the user can identify one or more regions R-1 304A and R-2 306A of the raster image 300. The regions identified by the user are superimposed or otherwise presented on the raster image 300 via the display 302A. The user input is also provided to the segmentation module 322, which may be locally hosted at the mobile device or available to the mobile device via a network(s). The segmentation module 322 divides the raster image 300 into segments as shown via display 302B, taking into account the user input entered by the user via the UI 308. In one embodiment, the segmentation may be forced to designate segments corresponding to the user input (i.e., definitive guidance). In another embodiment, the segmentation is observed more loosely such that the segmentation makes efforts to provide a segmentation that includes the regional boundaries identified by the user, but is not precisely bound by such region(s) suggested by the user (i.e., suggestive guidance). Whether definitive or suggestive guidance is used at any particular time may be fixed (e.g., programmed into the segmentation module 322), or may be selectable by the user and/or selectable by the segmentation module based on segmentation criteria.

For purposes of a first example, it is assumed that the user identified one region, R-1 304A, prior to the segmentation process. In one embodiment, only one region is suggested, and upon completing the delineation of the suggested region, the segmentation module is automatically invoked. For example, a user can click and drag a cursor to create the desired region, and upon releasing the button (e.g., un-clicking) the region is established as the segmentation process is initiated. As depicted on display 302B, the segmentation module performs a segmentation that includes the identified R-1 304B, and one or more other regions such as regions 324-338 and 306B. For purposes of this example where the user selected a single region (R-1 304A), it is assumed that the segmentation module created region R-2 306B. As can be seen, region R-1 304B is substantially preserved by the segmentation process such that a resulting segment corresponds to the user-designated region R-1 304A. Had the user identified a different region R-1 304A prior to segmentation, the segmentation module 322 would perform segmentation taking that designated region into account. It should also be noted that a “proposed” segmentation may be presented, such as by showing the proposed segmentation, and allowing the user to accept or modify the proposed segmentation to create the actual segmentation.

When the segmentation has been established, the region presentation module 340 converts one or more of the various segments 304B, 306B, 324-338 into a narrow-screen layout as shown by display 302C. Generally, narrow-screen layout involves reformatting content to fit the width of the device display, adapting or removing tabular information, frames, multicolumn text, and other two-dimensional formatting directives as necessary. In one embodiment, all of the segmented regions are displayed in narrow-screen layout in a vertical sequence, where limited or no horizontal scrolling is required. Vertical scrolling may be performed in any known manner, such as by using a scroll bar 342. In accordance with another embodiment, the user may select one or more of the segmented regions 304B, 306B, 324-338 for display in the narrow-screen layout. The user may scroll to the desired regions in the segmented view, such as scrolling to region R-1 304B, and then select the region for viewing via the narrow-screen layout shown on display 302C. For example, if the user selects regions R-1 304B and R-2 306B from the segmented view shown via display 302B, the narrow-screen layout depicted on display 302C will include a narrow-screen view of these selected regions as depicted by regions R-1 304C and R-2 306C.

In a second example, it is assumed that the user identified multiple regions, R-1 304A and R-2 306A, prior to the segmentation process. In one embodiment, multiple regions can be designated, and another user input signal indicates completion of the region selection process. This may be effected using any UI 308 mechanism, such as the finish “F” button 316, selection of which causes the region selection process to end and the segmentation process to begin. As depicted via display 302B, the segmentation module performs a segmentation that includes the identified regions R-1 304B and R-2 306B, and one or more other regions such as regions 324-338. As can be seen, regions R-1 304B, R-2 306B are substantially preserved by the segmentation process such that resulting segments correspond to the user-designated regions R-1 304A and R-2 306A. When the segmentation has been established, the region presentation module 340 converts one or more of the various segments 304B, 306B, 324-338 into a narrow-screen layout as shown by display 302C. Again, all of the segmented regions may be displayed in the narrow-screen layout in a vertical sequence, or the user may select one or more of the segmented regions 304B, 306B, 324-338 for display in the narrow-screen layout. For example, if the user selects regions R-1 304B and R-2 306B from the segmented view shown via display 302B, the narrow-screen layout depicted on display 302C will include a narrow-screen view of these selected regions as depicted by regions R-1 304C and R-2 306C.

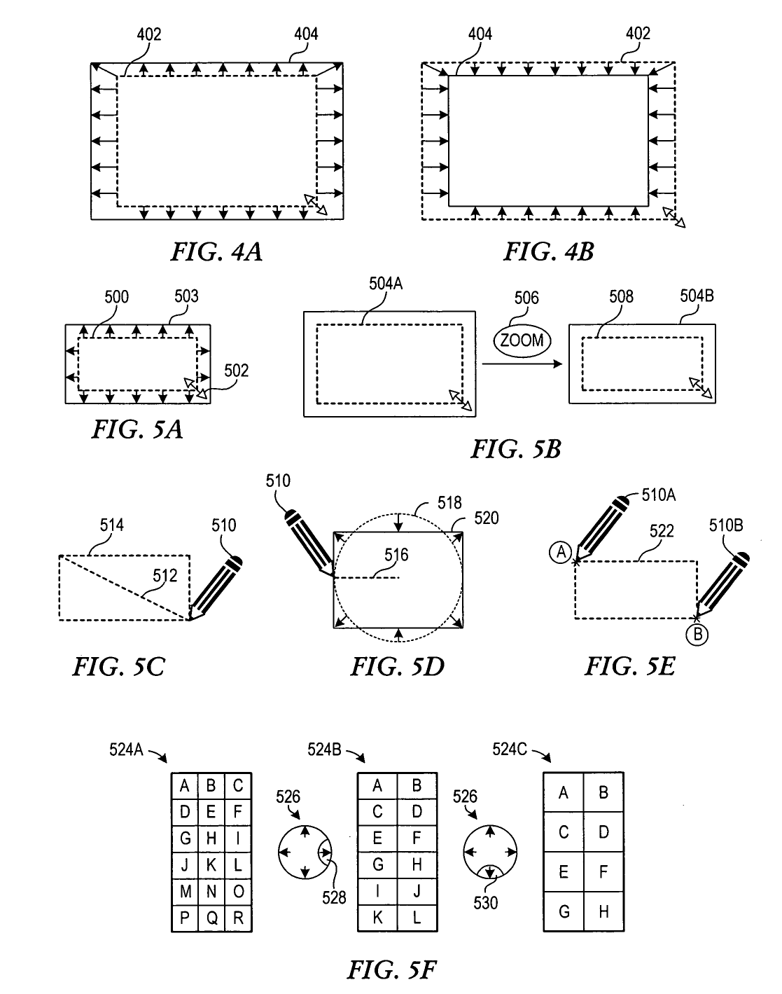

In accordance with one embodiment of the invention, the user provides guidance as to the particular region(s) to be preserved for the segmentation process, where the closest boundaries to the user's input become the boundaries of the corresponding segment. In one embodiment, this is effected using a snap-to-boundary feature (hereinafter “snap” feature). In this manner, the user does not need to be precise in delineating a region, but rather after the user identifies a region(s), the actual region boundaries are determined by “snapping” the drawn boundaries to the nearest likely boundaries. This is illustrated in FIGS. 4A and 4B. In FIG. 4A, the user has used a graphical pointer 400 to sweep a rectangular area 402 that approximates the region to which the user would like to designate for the segmentation process. Using a snap feature, the area 402 may be automatically snapped to the nearest most likely border 404. If the user does not agree with the snapping function, it may be disabled and/or the region may be edited as described in greater detail below. Analogously, FIG. 4B illustrates where the user has swept a region 402 larger than a likely actual boundary 404, and the snapping feature snaps the user's designated region 402 inward to the actual boundary 404. Such snapping features may be used for any geometric shape or area designated by the user. Determining such actual segment boundaries may be effected as described herein, or by consulting an internal “frame tree” representation of the web page as is known in the art. It should be recognized, however, that any manner of effecting such a snapping feature may be used in connection with the present invention.

It is also noted that any user interface functionality may be used to identify the desired regions for the segmentation process. FIGS. 5A-5F illustrate a non-exhaustive, representative number of different manners in which such regions may be designated by the user. FIG. 5A illustrates one embodiment where the user utilizes a mouse, trackball, joystick or other scrolling mechanism to sweep out an area 500 by a click-and-drag (or analogous) stroke of the cursor 502. Where snapping is enabled, the designated area 500 may be adjusted to the resulting segment 503. FIG. 5B illustrates a zoom feature, where the user can first designate a subset 504A of the raster image, activate a zoom function 506, and designate one or more areas 508 within the zoomed-in area 504B.

In other embodiments, other UI mechanisms may be implemented such as touch screen, touch pad, or other analogous UI mechanism. In the example of FIG. 5C, a stylus 510, finger, or other pointing device may be used to draw a line 512 which forms two of the corners of a rectangle 514, where the rectangle 514 defines the user's designated region for segmentation. Other geometric shapes may be used to designate a region(s) for segmentation. For example, as shown in FIG. 5D, a diameter or radius 516 of a circle 518 may be used to define the user's designated region for segmentation. Snapping may be used to associate the user's designated region 518 with an actual segment 520. In another embodiment, the stylus 5 10A, 510B (or other pointing device) is used to mark at least two points, shown as points A and B, which defines a region for segmentation. For example, two points may represent opposite corners of a rectangle 522, where the addition of another point (not shown) may represent points on a circle or other shape.

FIG. 5F illustrates another representative embodiment, where a grid is superimposed on the raster image, and the user is allowed to modify the size of the grid locations. For example, the grid may default or be set to a first grid pattern 524A. Using any appropriate UI mechanism, such as the directional scroll button 526, the user can change the size of the grid. For example, by pressing a horizontal directional arrow 528 on the directional scroll button 526, the grid pattern changes from three columns to two columns, thereby increasing the width of the grid areas as shown on grid pattern 524B. Pressing a vertical directional arrow 530 on the directional scroll button 526 reduces the number of rows in the grid as shown on grid pattern 524C. The user can select one or more resulting grid areas by selecting the corresponding grid area(s). The UI mechanisms described herein are merely examples, and the invention is clearly not limited to the representative examples set forth here. It should also be recognized that snapping features or other features may be used in connection with any UI mechanism.

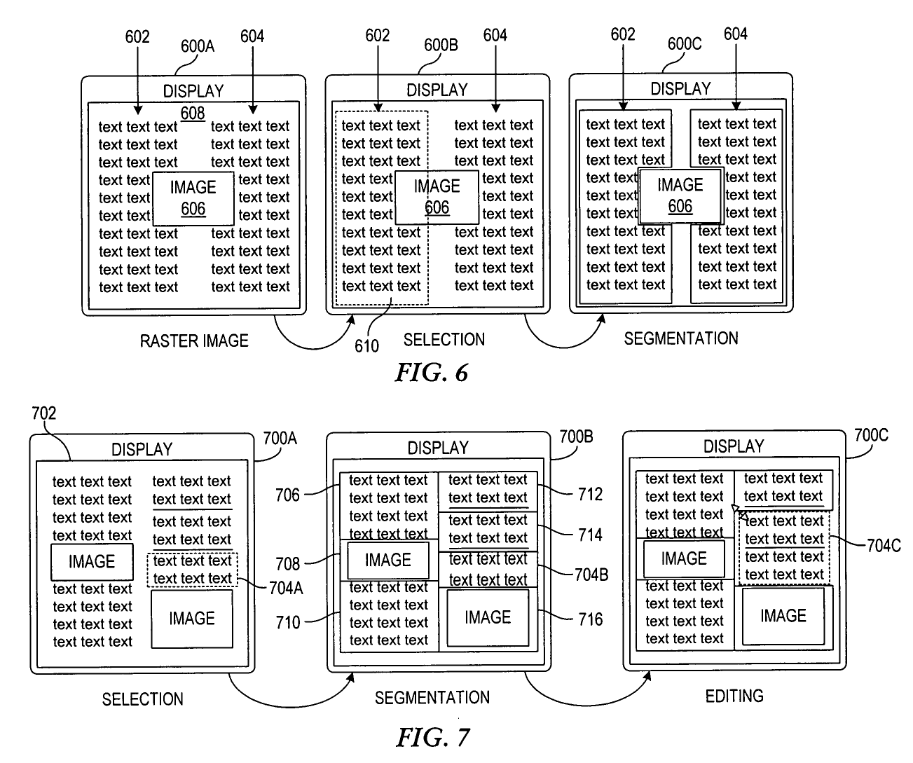

In accordance with one embodiment of the invention, the segmentation module allows for non-rectangular or other non-standard regions to be selected. FIG. 6 illustrates such an example, where a non-rectangular region is selected, even though the user designates a rectangular region. A first state of the display 600A illustrates two columns 602, 604 of text, and an image 606 integrated into the raster image 608. If the user wants to designate column 602 for use by the segmentation module, the user could provide user input that specifically includes the text in column 602 but excludes the portion of the image jutting into the text column 608. However, this could be a cumbersome process, as it requires lines to be drawn around the text of column 602 yet excluding the image 606. In accordance with one embodiment of the invention, the user can designate the desired region 610 as shown on display 600B. As can be seen, the designated region 610 includes the desired text of column 602, but also includes a portion of the image 606. The segmentation module recognizes that the text column 602 is substantially encompassed, while only a portion of the image 606 is included. As shown on display 600C, the segmentation can propose a region including the user's selected column 602, while recognizing that the image 606 is a separate region even though the user's selection included a portion of the image 606. This function is essentially an enhanced snap-to-boundary feature, where the region is snapped to the most likely boundary.

The user-designated regions may also be edited in accordance with one embodiment of the present invention. FIG. 7 illustrates a representative manner of editing a segmentation in accordance with the present invention. Editing may occur to regions designated by the user prior to segmentation, and/or to segments resulting from a proposed or final segmentation. In the illustrated embodiment, a first display 700A illustrates a raster image 702 of a page/document. The user selects a particular text region 704A to guide the segmentation process, which is depicted as a shaded area with a dashed border. A segmentation process occurs, as depicted on display 700B, resulting in segments 706, 708, 710, 712, 714, 716, and the designated region 704B. This resulting segmentation may be edited by the user in accordance with one embodiment of the invention. For example, as shown on display 700C, the user may change the designated region 704A to create new designated region 704C. The user can perform such editing using any of the available UI mechanisms, such as click-and-drag using a mouse, trackball, joystick, or other similar mechanism including those described in connection with FIGS. 5A-5F.

The user therefore has the ability to expand or shrink a region(s) that has been included in a segmentation. Further, additional facilities are provided in one embodiment to merge and/or split segmented regions. For example, the user could designate segmented regions 704B and 714 to be merged, resulting in the region 704C. Alternatively, the user could split a region, such as region 704B, into two or more regions. In accordance with one embodiment of the invention, the editing feature allows the user to edit a region(s) to designate any region(s) that could have originally been designated during the initial region hinting or suggestion stage.

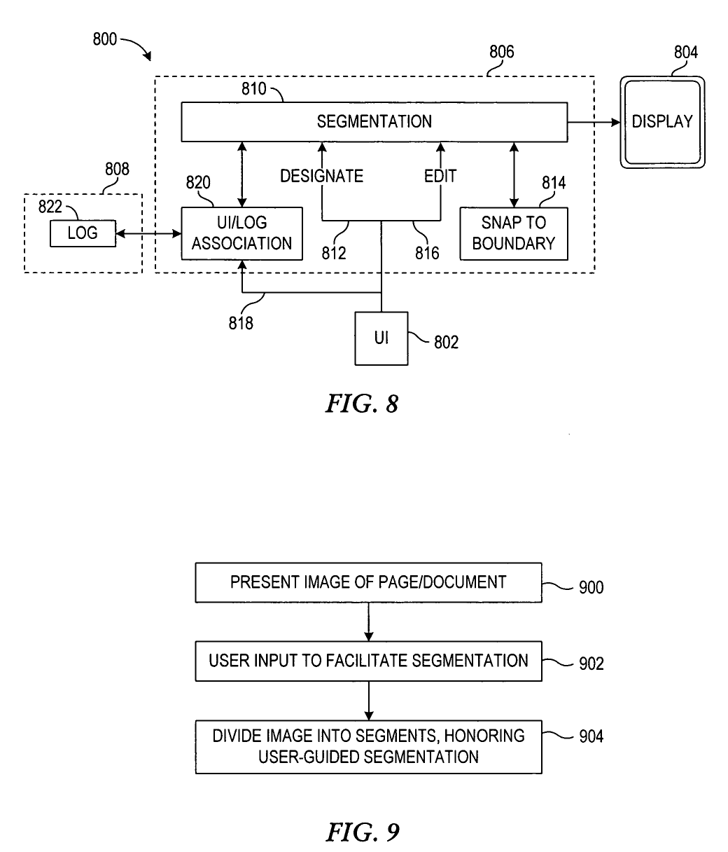

FIG. 8 is a block diagram illustrating an exemplary system for performing user-guided segmentation in accordance with the present invention. A communication and/or computing device 800 is illustrated, including a user interface (UI) 802, a display 804, a processing module 806, and a storage or memory 808. While the processing module 806 and associated storage/memory 808 may be provided via a server or other network element, it is assumed for purposes of the description of FIG. 8 that the processing and storage functions 806, 808 are performed at the device 800. However, the description provided herein is equally applicable to embodiments where the processing and storage/memory functions 806, 808 are performed remote to the device 800.

The user, by way of the UI 802, provides user input to the segmentation module 810 to designate one or more regions as shown on path 812. Using this guidance, the segmentation module 810 provides a segmentation that is presented on the display 804. A snap-to-boundary module 814 may be implemented in connection with the segmentation module 810 to snap the user designated region to a more suitable region, as previously described. If editing is allowed, the user may provide additional user input to the segmentation module 810 to redefine one or more regions as shown on path 816. In such a case, the segmentation module performs a new segmentation based on the updated user input, and presents the segments via the display 804. The presentation on the display may be the segmented raster image, to which the user can accept the segmentation to allow a narrow-screen layout of the regions to be presented. Alternatively, the segmentation module 810 may automatically present the narrow-screen layout of the segmented regions.

In accordance with one embodiment of the invention, the segmentation processes is enhanced by a learning feature. This optional feature allows the system to maintain a record of at least some (or all) of the user input, and associate the user input with a particular page/document using some identifying information such as a document file name, URL, etc. When the user subsequently returns to that file or URL, the system can use the previous user input to provide a fully automatic (e.g., default) segmentation. This is illustrated in FIG. 8 by the alternative path 818 from the UI 802 to the UI/log association module 820. The UI/log association module receives the user input from the UI 802, and compares the identifying information (e.g., file name, URL, etc.) to similar identifying information previously stored in a log 822 in the storage/memory 808. If a match is found, the corresponding segmentation stored in the memory 808 is provided to the segmentation module 810 to be automatically used as the desired segmentation. If no match is found, the user input is processed in the conventional manner, i.e., via path 812.

A learning feature such as that described above is particularly beneficial for web pages whose content changes regularly, while its layout remains relatively unchanged. For example, web sites that provide news often have a particular layout for top stories, local news, weather, or other categories. The categories often remain unchanged, while the news stories and consequently the links associated with these categories change regularly. Using a learning feature such as that described above, the segmentation may consistently and automatically segment the raster image in a manner previously identified by the user. The user would only need to provide segmentation guidance once, and the system can remember hot to segment that site in subsequent visits. In one embodiment, the system performs statistical learning, such that it can use user guidance provided at one site to properly segment other sites with similar layouts and/or categories, and to re-segment the same site if the layout changes slightly.

FIG. 9 is a flow diagram illustrating one embodiment of a method for facilitating viewing of a page/document on a device display. An image of the page/document, such as a raster image, is presented 900 on a display of a device. The user is allowed to submit input to identify one or more regions to guide the segmentation process, as shown at block 902. The image is divided 904 into segments, where the user input is honored during the segmentation process. Thus, the resulting segmentation includes a segment(s) that substantially corresponds to the region(s) designated by the user during the user hinting and/or editing stage.

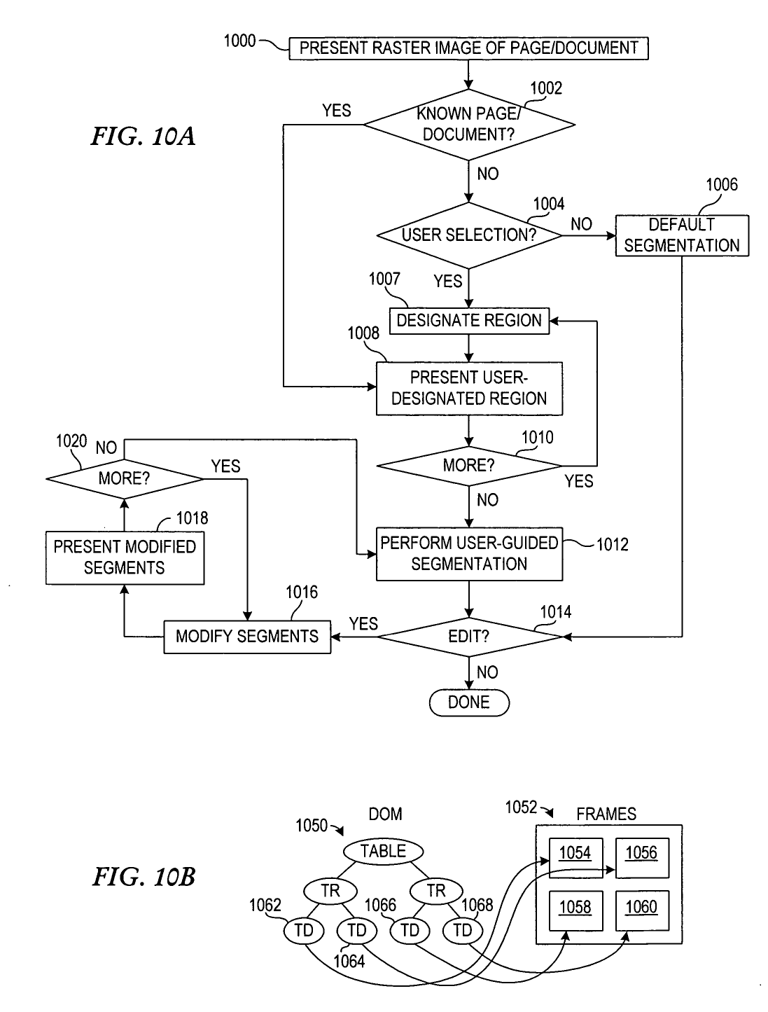

FIG. 10A is a flow diagram illustrating alternative embodiments of a method for facilitating viewing of a page/document on a device display. In the illustrated embodiment, a raster image of a page or document is presented 1000, such as displaying the raster image via a display on a communication device. Where a learning mode is implemented, it is determined 1002 whether the page/document is known, i.e. whether the URL or other identifying information has been previously stored for that page/document, thereby indicating that a previous user-guided segmentation is available. If it is determined 1002 that the page/document is associated with a known user-guided segmentation, the stored user-designated region(s) is presented 1008. If not, the user may opt to provide user input to the segmentation process. This is illustrated at decision block 1004, where it is determined whether the user has provided input to the segmentation process. If not, a default segmentation is provided as shown at block 1006. For example, the segmentation module performs a segmentation of the raster image without user input. In one embodiment, the user can edit the default segmentation as depicted at decision block 1014, which is described more fully below.

If the user opts to provide input to the segmentation process as determined at decision block 1004, the user designates 1007 a region as input to the segmentation process, and the designated region may then be presented 1008 with reference to the raster image. Where the user chooses to designate multiple regions as input to the segmentation process, it is determined 1010 whether the user wishes to designate additional regions. If so, one or more additional regions are designated 1007 and presented 1008 on the raster image. When all of the desired regions have been designated by the user, the user-guided segmentation is performed 1012.

In accordance with one embodiment, the user may edit a resulting (or proposed) segmentation. This is depicted at decision block 1014, where it is determined whether the user has elected to edit the segmentation. If not, the segmentation is complete, and the various segments may be properly presented via the display such as in a narrow-screen layout to facilitate viewing. If the user chooses 1014 to edit the segmentation, the segments resulting from the segmentation are modified 1016, such as by adding or deleting one or more new regions and/or modifying any segments resulting from the segmentation. The modified segments may be presented 1018. If more modifications are to be made as determined at decision block 1020, the user may make further modifications 1016. When all desired modifications are made, the user-guided segmentation is again performed 1012. This editing procedure may occur until the user is satisfied with the resulting segmentation.

When segmentation occurs as previously described, the resulting segments (or a subset thereof) may be automatically presented in the alternative viewing mode, such as a narrow-screen layout. In other embodiments, the user selects which one or more of the resulting segments are to be presented in the alternative viewing mode. For example, where a segmentation results in multiple segments, each segment may be associated with a link or other identifier such that when the user selects a particular segment, it is thereby designated for display via the alternative viewing mode.

Thus, a fundamental functional component involves the partitioning of a web page(s) into segments or “focus regions.” While the quality of a segmentation or partitioning may be a subjective notion, some beneficial guidelines in performing such a segmentation include ensuring that the individual segments are clearly visible in the thumbnail (e.g., raster) image, creating contiguous and convex regions, refraining from separating paragraphs or other logical units across segments, and maintaining segments within a specified size. “Size” may be defined in a variety of manners. For example, one manner of defining size is that the size |x| of a region x is the number of pixels occupied by the content (text, images, form controls, etc.) contained in that segment. It is common for published content to follow a grid-based layout, where content streams through rectangular regions on the canvas. This holds true for HTML content as well. Web browsers typically calculate the grid layout of an HTML document using a hierarchical rectangular structure known as a frame tree. Not to be confused with the HTML <frame> element, a frame in this sense refers to a visual pane that includes content and the location of that content on the canvas. Frames may contain other frames, in a hierarchical way. Together, this frame tree corresponds to the hierarchy of the Document Object Model (DOM), as illustrated in FIG. 10B. For example, a 2×2 HTML table 1050 has a frame 1052 that corresponds to the table 1050, and four children frames 1054, 1056, 1058, 1060, one for each table data cell (<td>) 1062, 1064, 1066, 1068 of the DOM.

Frames provide a good starting point for region-finding, since they capture the hierarchical visual structure of a web page. To narrow the search space for regions, one aspect of the present invention involves consideration of only regions that correspond to individual nodes in the frame tree, or to a sequence of sibling nodes. But even with this restriction, the search space may be exceedingly large; e.g., a frame with n children has 2ⁿ different partitions into regions. In accordance with one embodiment, a “greedy” search strategy is employed. Working from the root frame node, the frame tree may be recursively divided, selecting divisions that minimize the variance in size of the resulting regions. More particularly, assume that a frame node x has children {x₁, x₂, x₃, . . . xₙ}. Inserting a seam somewhere in this sequence, the expected size of the resulting regions is E=(|x₁|+|x₂|+ . . . +|xₙ|)/2. The score Sₖ of placing a seam before child k is the inverse of the variance in size of the resulting halves as shown in Equation (1):

$${S}_{k} = \frac{1}{{( \vert {x}_{1} \vert + \vert {x}_{2} \vert + … + \vert {x}_{k - 1} \vert - E )}^{2} + {( \vert {x}_{k} \vert + \vert {x}_{k + 1} \vert + … + \vert {x}_{n} \vert - E )}^{2}} \qquad Equation ( 1 )$$

Thus, a division that results in a more even division of content receives a higher score. Such an algorithm may be stated as follows.

Identify the best seam for the root frame; add the resulting left and right regions to the fringe.

While there are regions in the fringe larger than the maximum region size:
Remove the largest region, x, from the fringe;
Identify the seam Sₖ in x with the maximal score according to Equation (1);
Place the resulting left and right regions into the fringe.

Note that such a region-finding approach does not take into account the actual content of a frame node. An ideal region-finding algorithm would notice that two adjacent frame nodes have similar characteristics; for example, both consist of a list of hyperlinks, or both are pure text, or both contain only images.

Even after a thumbnail image has been generated, the system does not yet have input as to which segment(s) of the web page should be “active” and rendered in the alternative (e.g., narrow-screen) layout. In accordance with various embodiments of the invention, the system may wait until the user selects the segment(s), or may display the first segment by default, or to select a default active segment. In the latter case, the default active segment may be, for example, in the top left corner of the page or other predetermined presentation location. The default active segment may also be determined using a category of the segments, such as automatically selecting the region containing the start of the “main content” of the page, as sections of a web page may be automatically detected. Other predetermined criteria than the positional and categorical criteria described above may also be used in connection with the present invention.

In cases where the user is requested or expected to identify the segment(s) to be presented in the alternative view, the user may experience difficulty in selecting the desired segment(s). This is particularly true in the case of mobile devices, which are inherently small to provide ease of portability, and are accordingly equipped with relatively small display screens. A typical mobile device user may find it difficult to indicate an active region within the thumbnail page image. A mouse, pointing mechanism, or other random-access selector on phones and PDAs can be cumbersome to use, and in many cases these devices are not equipped with such facilities. Users may find themselves forced to tab through the regions in the page map until they reach the desired one.

One embodiment of the present invention mitigates such user entry obstacles by allowing users to indicate their desired region with as few as a single key press or other UI entry, and does not require that the device be equipped with a random-access selector. This aspect of the invention enables interacting with a document map on devices that lack a mouse or other random-access selector, or where selection via such a mechanism is otherwise cumbersome. A label is assigned to each identifiable segment of a segmented page. These labels may be alpha, numeric, alphanumeric, symbols, or other indicia that may be input via the device. User convenience may be enhanced by associating more readily available indicia with the labels. For example, assuming that the total number of resulting segments from a segmentation process is ten or less, each region may be labeled uniquely with a number from 0 to 9 corresponding to the numeric digits on keypads of mobile phones and other mobile communicators. For numbers of segments greater than ten, two-digit numbers may be entered (e.g., 00-99), or alpha characters and/or other symbols may be used.

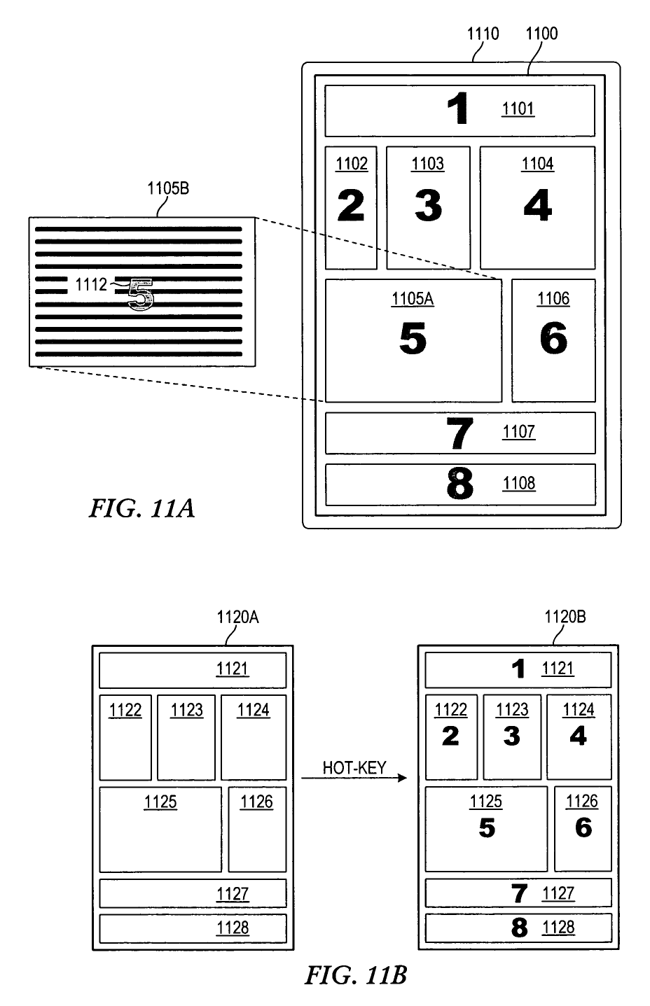

FIG. 11A is a block diagram illustrating an exemplary embodiment of segment labeling in accordance with the present invention. In the illustrated embodiment, an image of the web page or other document 1 100, such as a raster image or thumbnail, has been segmented or otherwise divided into a plurality focus regions or segments 1101-1104, 1105A, 1106-1108. This segmentation may include non-user-guided segmentation, or user-guided segmentation as previously described. Alternatively, the segments 1101-1104, 1105A, 1106-1108 may represent regions proposed prior to an actual segmentation process. In any case, the regions or segments of the document 1100 are presented via a display screen 1110 such as a mobile device display.

In accordance with one embodiment of the invention, each segment of the document image 1100 is demarcated and labeled with some perceivable indicia. In the illustrated embodiment, the indicia is represented by numeric symbols ranging from 1-8, each corresponding to one of the segments 1101-1104, 1105A, 1106-1108. In this manner, the user can simply enter a number(s) 1-8 on a numeric keypad of the device in order to select that segment for viewing. When a segment has been selected, the presented image on the display 1110 can be switched from the thumbnail layout which displays multiple (or all) segments of the document image 1100, to a narrow-screen layout where the selected segment may be independently displayed to facilitate viewing of the segment content. Other indicia may be used, such as alpha or alphanumeric characters, symbols, or other indicia having corresponding indicia on the device from which the selection is made.

In one embodiment, the web page or other document 1100 includes a script, such as javascript, to poll for the “event” associated with the user's pressing of a key on the device's keypad. Such a script may be associated with the browser or other similar application on the device. In another embodiment, hyperlinks may be associated with the keys or other input mechanisms. For example, associating hyperlinks with numeric keys is supported in Extensible Hypertext Markup Language-Mobile Profile (XHTML-MP) via the “accesskey” attribute for the <a> element. Other currently known or future manners of identifying such user input are equally applicable for use in connection with the present invention, and the foregoing are merely representative examples.

The actual labeling may be performed in various manners. In one embodiment, the labeling may be implemented in a relatively unobtrusive manner by utilizing alpha blending, hot-key toggling, or variations thereof. Alpha blending refers to overlaying a semi-transparent label over the region, so that the information under the label can still be seen. This is generally depicted in FIG. 11A, where segment 1105B includes a semi-transparent label 1112 having the numeric value of “5,” where the underlying text can be at least partially seen through the label 1112. The user can select the desired region by pressing the button or otherwise activating the keypad symbol corresponding to the label associated with the desired region. Other UI mechanisms may also be employed in connection with such labeling, such as voice commands, where the user speaks the label name of the desired region.

Hot-key toggling involves concealing the labels until the user activates them. For example, the user can press a particular key on the device, such as the “*” or “#” key, to reveal the labels. The labels may be displayed during the time the user continues to activate the predetermined key (e.g., holds the “*” or “#” down). Alternatively, the labels may be revealed for a predetermined time duration, or until the user presses the key again or a different key (e.g., a “sticky toggle”), or until any other preconfigured event transpires. A representative hot-key toggling embodiment is illustrated in FIG. 11B. A first display image 1120A includes a plurality of segments or regions 1121-1128, where no labels are presented. When the user presses the hot-key or otherwise activates a particular UI function, the labels 1-8 are presented in their respective segments/regions 1121-1128 as shown in the second display image 1120B. Again, other UI mechanisms other than key entry may also be employed in connection with such hierarchical labeling, such as voice commands where the user speaks the label name of the desired region.

Labeling in this manner may also be performed in a hierarchical manner in accordance with the invention. In hierarchical labeling, the segmentation is further organized such that there are multiple levels of segmentation. Higher levels have fewer and larger regions, while lower levels may include more numerous and smaller regions. In one embodiment, the relationship is such that each region has one parent region in the level above that contains it completely, except for the regions in the top level which have no parents. An optional restriction may then be imposed where the number of child regions under a given parent region (or, in the case of the top-level regions, the number of top-level regions themselves) are never be more than the number of keys available for mapping. For example, the number of keys available for mapping where the device includes a numeric keypad may be ten, one for each digit 0-9. The interaction modality would then be that the user first keys in the region containing the desired region, and the rendered proxy “zooms” into that region and presents the next level down, and so forth until the desired region is finally selected at the lowest level. In one embodiment, a “back” button or other similar UI mechanism is provided to allow the user to climb back up the hierarchy in case of a mistake or reversal of decision. In another embodiment, if the user has not selected a region within a predetermined time duration, the hierarchy automatically returns to the previous level, or to the top level.

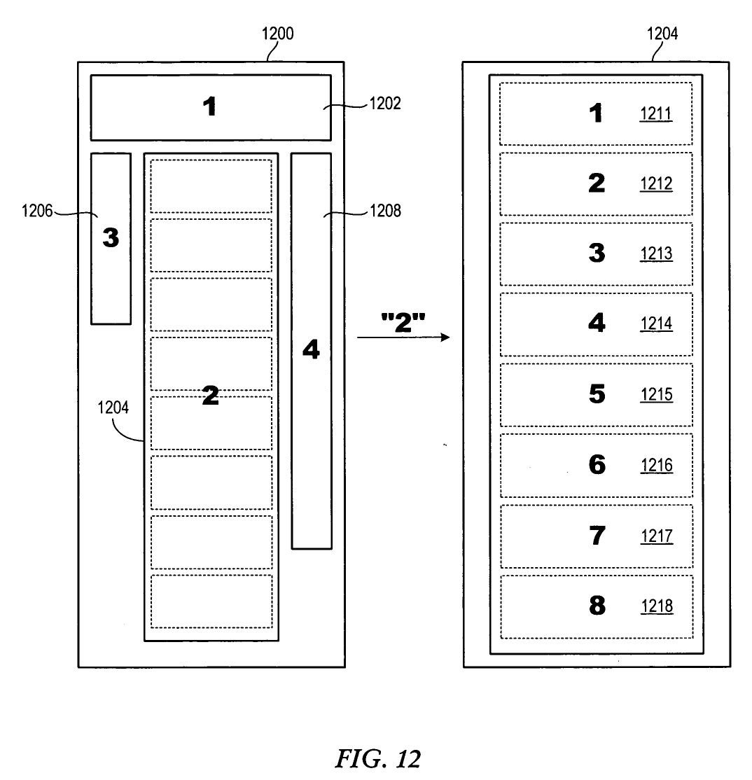

FIG. 12 illustrates an example of hierarchical labeling in accordance with one embodiment of the invention. A page 1200 is segmented to include four selectable regions 1202, 1204, 1206, 1208 and is presented via the device display screen. In this example, segmented page 1200 represents the top level. For purposes of illustration, it is assumed that the user selects the region with label “2” by, for example, pressing the “2” key on the device keypad. The display changes to present segment 1204, which is itself segmented to include a plurality of selectable sub-regions 1211-1218 having corresponding labels of 1-8. Selection of one of the labels of sub-regions 1211-1218 may present yet another set of child sub-regions, or alternatively may present the content of the selected sub-region where the hierarchy is at the lowest level or the user otherwise directs the device to present the content of the selected sub-region.

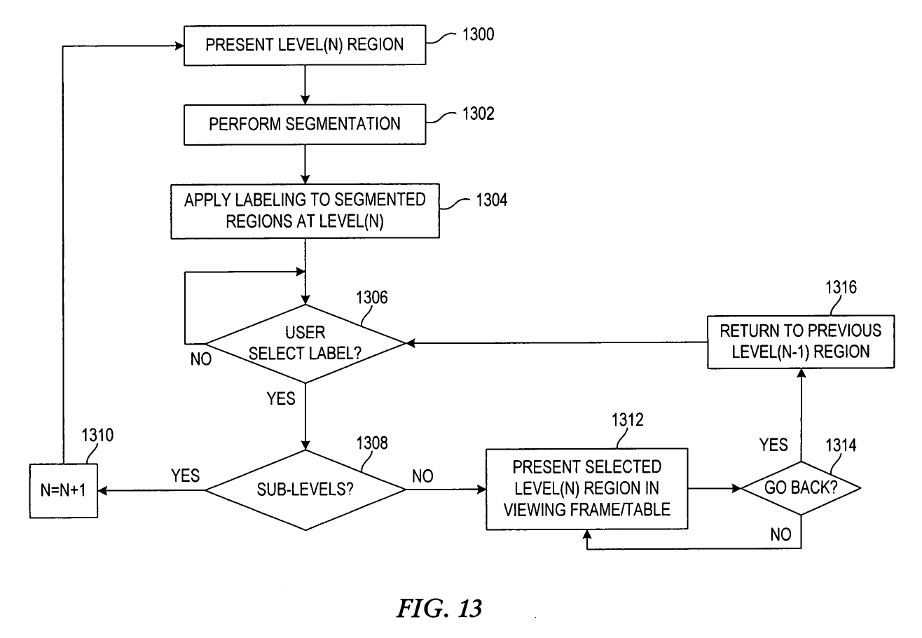

FIG. 13 is a flow diagram illustrating a method for executing hierarchical labeling in accordance with one embodiment of the present invention. A first level(N) region is presented 1300, where N is initially “1” representing the top level. At the top level, the “region” may represent a document map or other raster image of a web page, document, etc. Segmentation of the document map is performed 1302, which may involve an actual segmentation or proposed segmentation. Labeling is applied 1304 to each of the resulting segmented regions associated with level(N). When the user selects a region by entering the corresponding label as determined at decision block 1306, it is determined 1308 whether that selected region has associated sub-levels, i.e., whether hierarchical segmentation and labeling is to apply to the selected region. If so, the next level of the hierarchy is reached, as represented by incrementing N 1310 and presenting 1300 the selected region at the new level(N). Segmentation is again performed 1302 on the current level(N), and labeling is applied 1304 to the new segmented regions for selection 1306 by the user. This process continues until the currently-selected region has no further sub-levels as determined at decision block 1308, thereby indicating that the hierarchy is at the lowest level, or the user has elected to view the region associated with the current (but not lowest) level. In this case, the selected region associated with level(N) is presented 1312 in the viewing frame or table. The user may also opt to go back a level as depicted at decision block 1314, and if so the display returns 1316 to the previous region associated with level(N−1). The user may also go back multiple levels if desired.

It should be noted that such labels, whether in a hierarchical arrangement or not, may be entry-bound rather than key-bound. In such a situation, the segmented image would feature labels that are not necessarily key bindings, but rather involve the entry of unique numbers or characters such as multi-digit numbers, short words, or the like. In one embodiment a multi-key buffer may be employed, where all labels are of the same length and the user keys in the multi-key values. When the proper number of keystrokes has been entered, the region or sub-region matching the multi-key entry is presented. In another embodiment, a text-entry box may be implemented, which allows variable-length labels to be used, as well as in-place editing to correct entry errors as the possible expense of having to press an “enter” key or equivalent thereof after the entry is complete.

One representative implementation in accordance with the invention involves generating a top level image or “document map,” and marking it with boundary lines where the segment divisions are located. The different segmented regions may be distinguished using different colors. If the number of regions is less than or equal to the number of available keys, each region may be assigned to a different key, and the label for that mapping may be placed in the corresponding region on the rendered proxy. For alpha blending, the color of the label may be modulated on a per-pixel basis by weighted-averaging it with the color value that already exists at that location. For hot-key toggling, separate versions of the document map with and without labels may be generated, and the appropriate existing facilities (e.g., client-side scripting for web pages) may be used to toggle between the two images upon request. If the number of regions is greater than the number of available keys, the regions may be clustered to form a hierarchy as previously described. In such case, for each parent region (and for the top level) the key assignment may be performed as in non-hierarchical labeling, and a labelled image generated for each. As the user progresses through the hierarchy, the rendered proxy may be updated with the image of the current level.

Region labeling in accordance with the invention offers a number of benefits that can apply to both mobile devices and larger-scale computing systems such as desktop and workstation computers. Labeling broadens the applicability of interactive document maps to a wider range of devices and generally accelerates the speed of interaction with rendered proxies. For instance, without the present invention, selection of regions of a segmented minipage is difficult to the point that minipage implementation may simply be impractical. For devices such as desktop computers that are associated with larger displays, region labeling according to the invention can significantly enhance the speed at which users can interact with web pages. On lengthy web pages whose content is frequently updated but whose layout remains substantially constant (e.g., news sites), it is easier to zoom into the section of interest by pressing keys in rapid succession than to scroll and locate the desired region using scroll bars and a mouse. For example, on a news web site, the key “1” might be mapped to the area containing just the top stories. So the user could go that news web site, press “1” to remove all visual clutter and see, at a glance, just the top stories.

In various embodiments described above, selection of a region involves removing an existing image on the display of the device, and displaying the selected region. The need to replace the current display with the selected region is largely due to the small display size available on mobile devices. For example, web content is almost always composed with the implicit assumption that its consumer will be using a desktop or analogous computer having a relatively large display. Such larger displays typically do not require that a thumbnail/raster image of a web page or other document be created, as the original image is generally viewable in its original form on such displays. On the other hand, mobile devices and other devices having display sizes smaller than that to which the page was designed require significant scrolling in both the horizontal and vertical directions to view a page intended for a larger display. This can be an onerous task for the mobile device user, as mobile device UI mechanisms are also small and more difficult to manipulate than their desktop counterparts. Therefore, a minipage image of the original web page, segmentation, and region selection capabilities may be used for mobile devices to overcome some of these difficulties. Due to the small display size, presentation of a selected region involves the replacement of the original minipage image with the selected region.

However, some mobile devices are being designed with larger displays and higher resolutions than their predecessors, although smaller than the displays of desktop computers. These “medium-sized” displays may have resolutions on the order of 640×320 pixels, such as is the case with Nokia Series 90 Platform devices. Notwithstanding the larger physical display dimensions and resolutions, the fact that these medium-sized displays are still smaller than the display size to which the web page was designed presents issues similar to those faced by small-sized displays. More particularly, a raster image may still be required to avoid undue horizontal and vertical scrolling, as a mismatch may still exist between the content designed for large screens and the device accessing the content.

One solution is to use the approach described above, where the web page is shrunk to fit into the size of the terminal's display. However, for medium-sized displays, generating the raster image is more CPU-intensive as well as memory-intensive, and transmitting this image over traditional cellular networks from a server may present unacceptable latency. One embodiment of the present invention addresses this problem by presenting adjacent views of the raster image and a narrow-screen layout of the currently-active region. As the user selects from demarcated regions from the raster image view, the adjacent view is updated to display the narrow-screen view of that region.

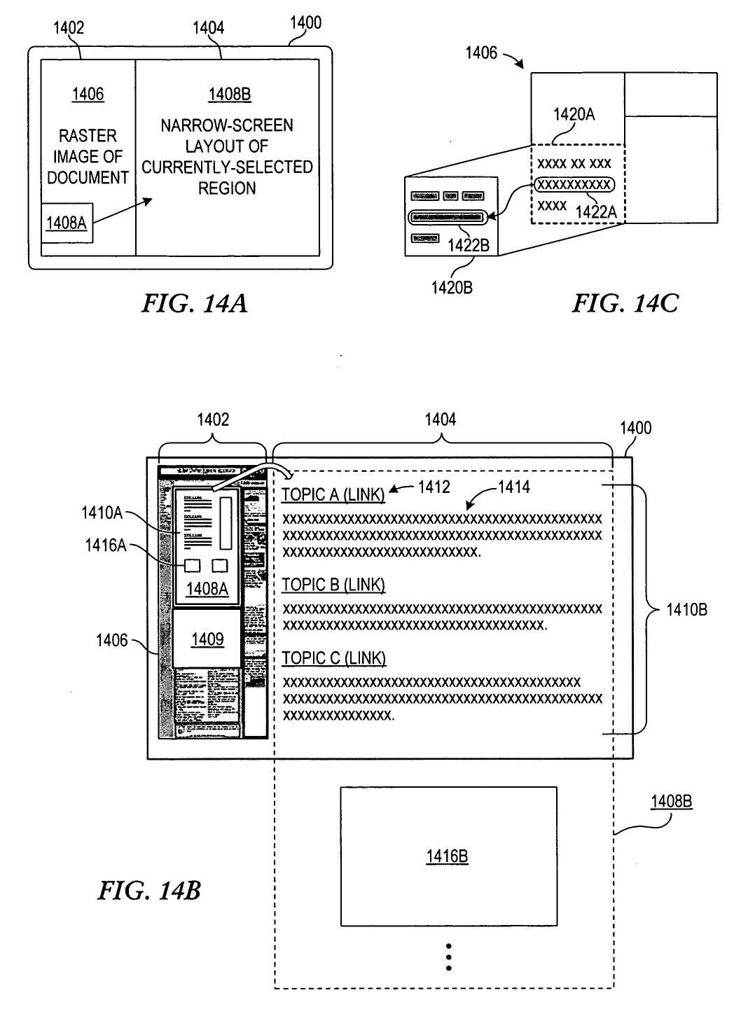

FIG. 14A is a block diagram generally illustrating an exemplary embodiment of a split-screen viewing display 1400 in accordance with the present invention. At least two adjacent views or “panels” 1402, 1404 are provided, which are oriented in a side-by-side orientation in the exemplary embodiment. The adjacent display panels of the communication device include a single display element having adjacent presentation areas, as well as a display having multiple display units (e.g., side-by-side display screens). The first panel 1402 presents a raster 1406 image or document map as previously described. The raster image 1406 represents a thumbnail of the original web page or document that has been scaled to fit the dimensions of the first panel 1402. This raster image 1406 is segmented into visually discrete regions, as previously described in connection with the segmentation process. The resulting regions may be demarcated using symbol overlays, distinguishing borders (e.g., different colored borders, different border line widths, etc.), distinguishing region shading, highlighting or grey-scaling, or the like.

Each resulting region may be individually hyperlinked to facilitate user selection of a desired region(s). In one embodiment, the raster image 1406 is rendered as an imagemap. Where the target browser lacks imagemap support, other rendering methodologies may be employed such as, for example, rendering using the XHTML <table> element with hyperlinked images comprising the table's cells. The user of hyperlinks in this fashion allows the user to select a desired region, such as region 1408A, where the selected region becomes the currently-active region for presentation in the second panel 1404.

The second panel 1404 presents the currently-active region 1408B in a narrow-screen layout for ease of viewing. The second panel 1404 may be delivered as, for example, XHTML markup. The region presented via the second panel 1404 may be currently active where the user has selected that region from the raster image 1406, or due to a region being automatically selected for presentation via the second panel 1404 in response to an occurrence of a predetermined event(s) or a default situation. The currently-active region 1408A may also be distinguished from non-active regions in the raster image 1406, such as by using uniquely colored/grey-scaled borders, shading, highlighting, etc.

When the page is first loaded into the first panel 1402 and before the user has selected a region, the system may select an initial or default active region to present in the second panel 1404. This automatic region selection may be accomplished using predetermined criteria, such as criteria based on segment position, segment category, etc. For example, the region in the top left corner of the page 1406 may be used as a default region to present via the second panel 1404. As another example, the default region may be a region associated with a particular portion or category of the page, such as the start of the “main content” or other predetermined page portion. One manner for locating a category such as a “main content” category may be determined as described herein and as set forth in co-pending U.S. patent application Ser. No. 09/851,404, entitled “Reorganizing Content of an Electronic Document,” the content of which is incorporated herein by reference.

When the user selects a region from the first panel 1402, the narrow-screen view of that region 1408B is presented in the second panel 1404. When the user selects a hyperlink in the second panel 1404, a Uniform Resource Locator (URL) or other analogous page/document address is loaded. A thumbnail image of this “new” document associated with the URL appears in the first panel 1402, and a narrow-screen view of the default region may be presented in the second panel 1404. This operation, where a second panel 1404 link is selected, is referred to herein as URL selection.

FIG. 14B is a block diagram illustrating a more particular embodiment of the split-screen viewing display 1400 in accordance with the present invention. FIG. 14B uses reference numbers corresponding to those used in connection with FIG. 14A where appropriate. The first panel 1402 includes a document map 1406 that has been segmented into a plurality of regions. Either by default or by user selection, region 1408A is the currently-active region, and is therefore presented in the second panel 1404 as region 1408B. In accordance with one embodiment of the invention, the content associated with region 1408A is reformatted to the narrow-screen layout associated with the second panel 1404. For example, region 1408B may be formatted such that section 1410A of the currently-active region 1408A may be formatted to be listed first in the narrow-screen layout of region 1408B. Such a section 1410B of the narrow-screen layout 1408B may include links 1412 and/or text 1414, which are formatted to the width of the second panel 1404. Other content elements, such as image 1416A of the currently-active region 1408A may then be presented following section 1410B as depicted by the reformatted image 1416B. Still other content elements can follow, such that all or particular ones of the content elements associated with the region 1408A are presented as the reformatted region 1408B. In this manner, the currently-active region 1408A may be viewed via the second panel 1404 using only vertical scrolling or no scrolling.

As indicated above, a region 1408A can be selected from the raster image 1406 to present a reformatted region 1408B in the second panel 1404. In one embodiment, the user can scroll within the second panel 1404, and if the user reaches a boundary of that region 1408B while scrolling, an adjacent region from the raster image 1406 can be automatically presented to the user. For example, if the user has scrolled down in the second panel 1404 and has reached the end of the displayed region 1408B, the next region 1409 may automatically be reformatted to fit the second panel 1404, which either displaces or continues from the previously presented region 1408B. Analogously, a region above the current region 1408A in the raster image 1406 may be automatically presented in the second panel 1404 where the user scrolls up past the start of the currently viewed region 1408B. In one embodiment, this is visually indicated on the raster image 1406 by always highlighting the currently-active region, including where the user has automatically entered a new region as described above. Thus, when a user enters a new region by scrolling in the second panel 1404, the highlighted (or otherwise delineated) region changes. Such automatic presentation modification may be implemented using, for example, HTML relative anchors or other analogous linking methodology.

In operation, a web page or other document undergoes conversion to a raster image as well as a segmentation process, thereby producing the segmented raster image 1406. One or both of these conversion and segmentation processes may be executed locally on the device (e.g., associated with the browser or a separate library), on a web server, on a gateway provided by a wireless operator or Internet Service Provider (ISP), etc. Memory and Central Processing Unit (CPU) capabilities on current mobile devices may not be sufficiently robust to support such processes from a practical standpoint. The computational resources utilized to generate a rendering of a web page may be greater than that provided by most of today's mobile devices, and therefore these functions may be hosted by web servers, gateways, etc.

However, computational shortcuts may be implemented in accordance with the invention, such as through the use of techniques such as “greeking” where characters and fonts are only approximated, which may range from course to relatively precise approximations. In another embodiment, the individual letter and font rendering of the imagemap or thumbnail rendering can be elided in place of, for example, colored rectangles or other indicia that conveys the positioning of the text. Referring briefly to FIG. 14C, an example of such an embodiment is illustrated. A representative portion of the raster image or document map 1406 is shown. A particular region 1420A is illustrated having text or other characters in its original format, i.e. as it would be presented via an original web page. Region 1420B depicts a representation of how the actual characters may be presented, in order to conserve computational resources. More particularly, the character information of region 1420A may be depicted by rectangles or other shapes, colors and/or the like as shown at region 1420B. Such “shapes” for purposes of this embodiment need not be precise shapes, and may include symmetrical or non-symmetrical shapes, blurred areas having no definite boundaries, and the like. In one embodiment, the original text segment 1422A may be replaced with a colored rectangle 1422B. Since the original image is already relatively small and not easily read at the text/character level, “approximating” the character information in this manner reduces the computational burden otherwise involved in computing a full image of the page. It is noted that as mobile device memory and processing power continues to increase, local implementations becomes increasingly feasible.

Where these computations are performed remote from the device, a frameset is delivered to the mobile device browser in accordance with one embodiment of the invention. Again referring to FIG. 14B, the frameset may include the resulting segmented image 1406 in one frame, and the contents of the refactored first/default segment in the other frame. If frames are not supported, a table or other appropriate data structure may be used instead. In one embodiment, each link in the segmented image 1406 is set to load a particular narrow-screen region in the second panel 1404 without affecting the image 1406 frame. In accordance with one alternative embodiment, a new frameset may be delivered upon each request or selection by the user. Such an embodiment may be useful where, for example, the raster image 1406 were to change as the user selected each region. An example of a changing raster image 1406 is where the currently-active region 1408A of the raster image 1406 is highlighted or otherwise distinguished from the non-selected regions.

In another embodiment of the invention, regions on the raster image 1406 may be highlighted as the corresponding content changes in the second panel. On a typical computer browser, a user's interactions, such as moving a mouse over a region or selecting an item in a list, may trigger an event handler that alters the content of the document. For example, moving the mouse over an icon may cause a pop-up menu to appear in another part of the page. Providing this functionality solely within a narrow-screen layout can be a challenge. For example, the pop-up menu may lie outside the viewable region, and will likely go unnoticed to the user. According to one embodiment of the invention, changes may be highlighted on the raster image 1406 in the first display portion 1402 as events are triggered and content changes in the original web page viewed in the second display portion 1404. In this case, the page is recreated to create a new raster image, which highlights the region containing the pop-up or other automated presentation modification. Although a new raster image will be created, much of the layout work can be cached, and modifications in the DOM can trigger “reflow” events in the DOM. Selection of the newly highlighted region can then be automatically selected or selected by the user for viewing.

In another embodiment, the split-screen viewing display 1400 need not use segments, but instead shows an overview image 1406 that is not segmented in the first display portion 1402, and the narrow-screen view in the second display portion 1404. In this embodiment, the overview image is highlighted or otherwise demarcated to show which content section is being displayed via the second display portion 1404. Therefore, the user can scroll up and down, and pan left and right to gain access to the entire document. While this scrolling/panning occurs, a highlighted portion on the overview image 1406 moves to identify the user's current location in the document.

An extension to the non-segmented embodiment described above is to allow the user to “jump” to a different section of the document by clicking on or otherwise identifying a location on the overview image 1406. The underlying content most closely associated with the selected location of the overview image will be displayed via the second display portion 1404. As the user jumps to a new location in this manner, the overview highlighting changes to show what is currently displayed in the second display portion 1404.

Such a non-segmented embodiment provides the advantage that the user is provided with constant feedback as to what is currently being viewed. Further, it allows for a seamless experience for the user to view an entire page. In situations where locating focus regions or otherwise segmenting the document is difficult, impossible, or impractical. Also, it shows the user both reformatted contents as well as the original page, and shows how the objects were serialized.

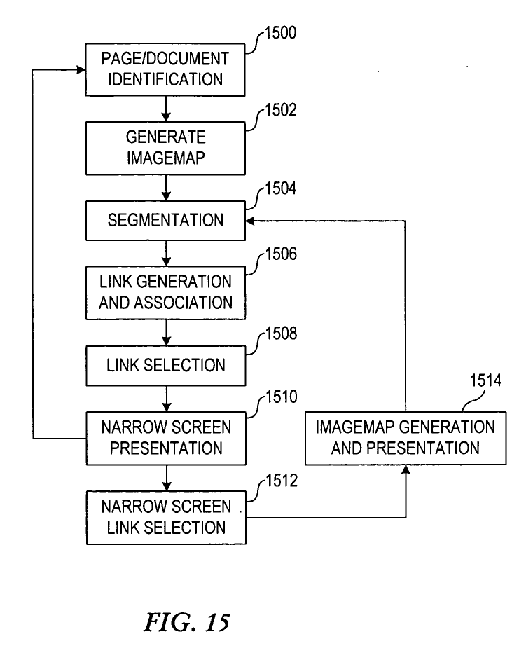

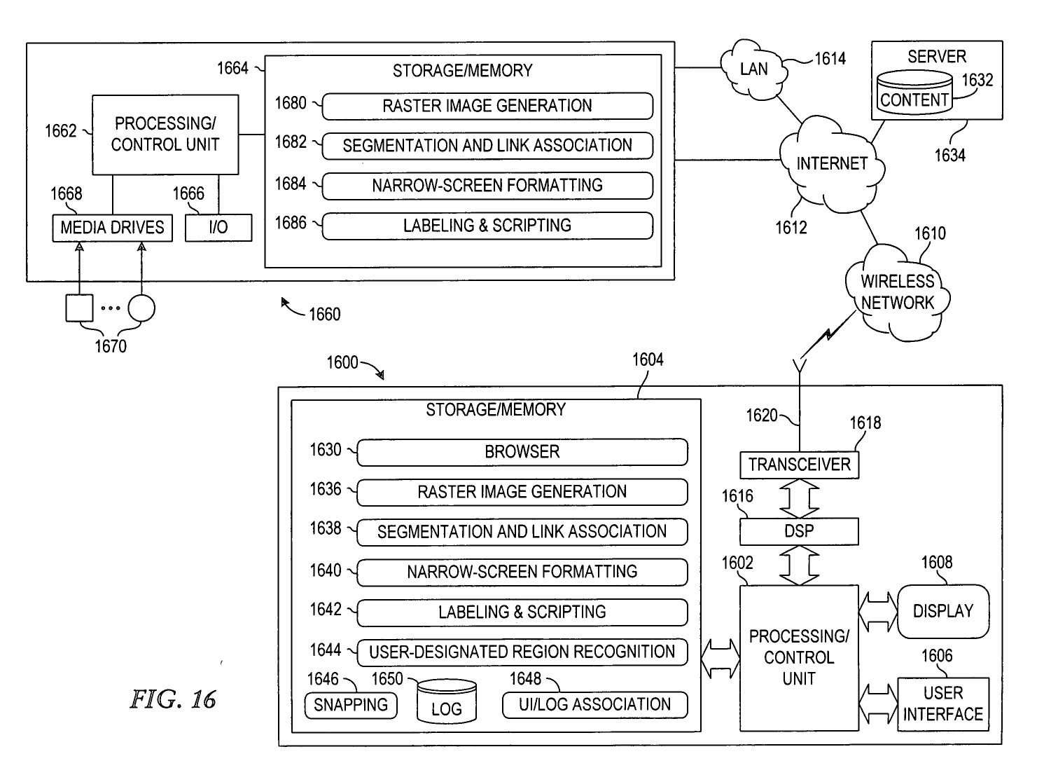

FIG. 15 is a flow diagram illustrating one embodiment for presenting a web page or other document using a split-screen methodology in accordance with the present invention. A web page or other document is identified 1500, such as by the user identifying a URL via the device browser. An imagemap (i.e. raster image) is generated 1502, which may be performed locally at the device or by a remote server or other network element. The imagemap is segmented 1504, which may be performed in a conventional manner or by way of user-guided segmentation as previously described. Links are generated and associated with the various regions of the segmented imagemap as shown at block 1506. The user is allowed to select a link as illustrated at block 1508, or alternatively a default or other region is automatically selected. The region associated with the selected/default link is presented 1510 in a narrow-screen layout to facilitate viewing. The user may identify 1500 further addresses if desired to reinitiate the process.

In one embodiment, a URL selection process is implemented. As previously described, this process allows a user to select links in the narrow-screen presentation as depicted at block 1512. When the user selects 1512 a link from the narrow-screen layout, a URL (or analogous) is loaded and a new imagemap of the corresponding content is generated and presented 1514 in the panel where the original raster image was presented. Segmentation of the new imagemap may again be segmented 1504, associated 1506 with links, and so forth to ultimately present 1510 new content via the narrow-screen layout.

A split-screen embodiment as described above is particularly beneficial for the emerging generation of higher-resolution, larger-display mobile devices. This new user interface exploits the trend towards larger display size and improved screen resolution of mobile phones and PDAs. The described system automatically decomposes a richly-formatted document (e.g., a web page) into distinct regions. In one embodiment, the system then renders the document in two adjacent panels including a “wide angle” view of the entire document, and a reformatted view of the currently-active region. This reformatted view corresponds to a narrow-screen layout where the content may be formatted to properly fit the screen width. In this manner, display space is consumed intelligently, where the user can view the entire page, while being able to focus on a reasonable amount of content in the refactored portion of the page. It allows the user to navigate intuitively throughout a web page even on a device whose display is smaller than conventional computing systems to which the content may be designed to fit.

Reformatting of the page into the narrow-screen layout in accordance with the present invention may additionally include reformatting to suit a particular purpose or need. For example, the page may be reformatted into the narrow-screen layout as previously described, and may optionally be further formatted to assist the visually impaired. More particularly, the font size of characters associated with the currently-active region displayed in the narrow-screen layout may be increased to allow the information to be more easily viewed. This is advantageous over prior systems where content is not reformatted to fit the viewing window, and therefore requires considerable scrolling.

Hardware, firmware, software or a combination thereof may be used to perform the functions and operations in accordance with the invention. The mobile devices in accordance with the invention include communication devices capable of communicating over-the-air (OTA) with wireless networks, and with landline networks by way of the wireless networks. Such mobile devices include, for example, mobile phones, PDAs, and other wireless communicators. The present invention is also applicable to landline computing systems and communicators. A representative system in which the present invention may be implemented or otherwise utilized is illustrated in FIG. 16.

The system includes a mobile device 1600 that utilizes computing systems to control and manage the conventional device activity as well as the functionality provided by the present invention. For example, the representative mobile device 1600 includes a processing/control unit 1602, such as a microprocessor, reduced instruction set computer (RISC), or other central processing module. The processing unit 1602 need not be a single device, and may include one or more processors. For example, the processing unit may include a master processor and associated slave processors coupled to communicate with the master processor.

The processing unit 1602 controls the basic functions of the mobile device 1600 as dictated by programs available in the program storage/memory 1604. The storage/memory 1604 may include an operating system and various program and data modules associated with the present invention. In one embodiment of the invention, the programs are stored in non-volatile electrically-erasable, programmable read-only memory (EEPROM), flash ROM, etc., so that the programs are not lost upon power down of the mobile device. The storage 1604 may also include one or more of other types of read-only memory (ROM) and programmable and/or erasable ROM, random access memory (RAM), subscriber interface module (SIM), wireless interface module (WIM), smart card, or other fixed or removable memory device. The relevant software for carrying out mobile device operations in accordance with the present invention may also be transmitted to the mobile device 1600 via data signals, such as being downloaded electronically via one or more networks, such as the Internet 1612 or other data networks, and an intermediate wireless network(s) 1610.

For performing other standard mobile device functions, the processor 1602 is also coupled to user-interface (UI) 1606 associated with the mobile device 1600. The UI 1606 may include, for example, a keypad, function buttons, microphone, joystick, scrolling mechanism (e.g., mouse, trackball), touch pad/screen, or other user entry mechanisms (not shown). These and other UI components are coupled to the processor 1602 as is known in the art. A display device 1608 is also associated with the mobile device 1600 as previously described.

The mobile device 1600 may also include conventional circuitry for performing wireless transmissions over the wireless network(s) 1610. The DSP 1616 may be employed to perform a variety of functions, including analog-to-digital (A/D) conversion, digital-to-analog (D/A) conversion, speech coding/decoding, encryption/decryption, error detection and correction, bit stream translation, filtering, etc. The transceiver 1618 transmits outgoing radio signals and receives incoming radio signals, generally by way of an antenna 1620.

The storage/memory 1604 stores the various client programs used in connection with the present invention, such as the local browser 1630 to request content 1632 from remote servers 1634. As previously indicated, imagemap generation, segmentation, and other functions may be executed locally on the device, at a web server, at a gateway provided by a wireless operator or ISP, etc. A first embodiment assumes that certain functions, such as imagemap generation and segmentation, are performed locally at the mobile device 1600. For example, the storage 1604 may include the raster image generation module 1636, operable in connection with the processor 1602, to create the thumbnail or imagemap that will be segmented. A segmentation and link association module 1638 divides the raster image into segments/regions, and associates links with each of the resulting regions. For split-screen operations, a narrow-screen formatting module 1640 may also be provided to allow content from selected regions to be properly formatted for a narrow-screen layout. A region labeling and scripting module 1642 may be provided to label regions for user selection, and to poll for keystrokes or other UI events associated with region labeling embodiments. A module 1644 for recognizing user-designated regions may be provided to identify regions demarcated by the user for segmentation 1638. As previously indicated, a snapping module 1646 may be used in such user-guided segmentation embodiments, as well as a UI/log association module 1648 and a database or other log 1650 for storing previous user input. These various mobile device modules are representative of the types of functional modules that may be provided on a mobile device in accordance with the invention, and are not intended to represent an exhaustive list.

Furthermore, it should be recognized that the aforementioned description is equally applicable to landline computing systems and communicators. For example, the transceiver 1618 may represent a network interface card (NIC), modem, or other device capable of exchanging information between such a computing/communication device and network elements.

FIG. 16 also depicts an embodiment where functions such as imagemap generation, segmentation, and/or other functions are executed at a web server, a gateway provided by a wireless operator or ISP, etc. This is depicted by the server 1660, which generically represents any such network element capable of performing such functions, and may or may not also be the server that is providing the pages or documents requested by the mobile device 1600. More particularly, the server 1660 includes a processing arrangement 1662, which may be coupled to the storage/memory 1664. The processor 1662 carries out a variety of standard computing functions as is known in the art, as dictated by software and/or firmware instructions. The storage/memory 1664 may represent firmware, media storage, and/or memory. The processor 1662 may communicate with other internal and external components through input/output (I/O) circuitry 1666. The server 1660 may also include media drives 1668, such as hard and floppy disk drives, CD-ROM drives, DVD drives, and other hardware capable of reading and/or storing information. In one embodiment, software for carrying out the operations at a server 1660 in accordance with the present invention may be stored and distributed on CD-ROM, diskette, removable memory, or other form of media capable of portably storing information, as represented by media devices 1670. Such software may also be transmitted to the device 1660 via data signals, such as being downloaded electronically via a network such as the Internet 1612, Local Area Network (LAN) 1614, wireless network 1610, and/or any combination thereof.

In accordance with one embodiment of the invention, the storage/memory 1664 and/or media devices 1670 store the various programs and data used in connection with the present invention. FIG. 16 illustrates that a server 1660 may perform some of the functions associated with the present invention, and provides results to the mobile device 1600. For example, functions such as the raster image generation, segmentation and link association, narrow-screen formatting, labeling and scripting, and/or other functions may be performed at the server 1660 as signified by the respective modules 1680, 1682, 1684, 1686.

The foregoing description of the exemplary embodiment of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather defined by the claims appended hereto.

1. A method for presenting content on a display of a communication device, comprising:
dividing a raster image of the content into a plurality of segments to create a segmented image;
presenting the segmented image of the content in a first portion of the display;
facilitating selection of at least one segment of the segmented image; and
presenting a visually enhanced view of the selected segment in a second portion of the display.

2. The method of claim 1, further comprising generating the raster image of the content prior to dividing the raster image into a plurality of segments.

3. The method of claim 1, wherein facilitating selection of at least one segment of the segmented image comprises facilitating user selection of the at least one segment via a user interface operable on the communication device.

4. The method of claim 1, wherein facilitating selection of at least one segment of the segmented image comprises facilitating automatic selection of the at least one segment based on at least one predetermined criterion.

5. The method of claim 4, wherein facilitating automatic selection of the at least one segment comprises establishing the at least one predetermined criterion to include a segment presentation location, and automatically selecting the at least one segment that corresponds to the established segment presentation location.

6. The method of claim 4, wherein facilitating automatic selection of the at least one segment comprises establishing the at least one predetermined criterion to include a segment category, and automatically selecting the at least one segment that corresponds to the established category.

7. The method of claim 6, wherein automatically selecting the at least one segment that corresponds to the established category comprises automatically selecting the at least one segment that corresponds to a main content category.

8. The method of claim 1, wherein:
facilitating selection of at least one segment of the segmented image comprises facilitating automatic selection of the at least one segment based on at least one predetermined criterion; and
presenting a visually enhanced view of the selected segment comprises automatically presenting the automatically selected segment in the second portion of the display.

9. The method of claim 1, wherein facilitating selection of at least one segment of the segmented image comprises associating labels with at least some of the plurality of segments, and enabling user selection of at least one of the labels to select corresponding ones of the plurality of segments.

10. The method of claim 1, wherein presenting a visually enhanced view of the selected image segment comprises formatting the selected image segment to fit a display width associated with the second portion of the display.

11. The method of claim 10, wherein formatting the selected image segment to fit a display width comprises generating a zoomed-in version of the formatted selected image segment and adjusting the zoomed-in version of the formatted selected image segment to fit the display width associated with the second portion of the display.

12. The method of claim 10, further comprising increasing a font size of characters of the formatted selected image segment displayed in the second portion of the display.

13. The method of claim 1, wherein presenting the segmented image of the content in a first portion of the display comprises presenting the segmented image of the content in a first side panel of the display, and wherein presenting a visually enhanced view of the selected segment in a second portion of the display comprises presenting the visually enhanced view of the selected segment in a second side panel that is horizontally adjacent to the first side panel.

14. The method of claim 1, further comprising distinguishing the selected segment from non-selected segments of the segmented image in the first portion of the display.

15. The method of claim 14, wherein distinguishing the selected segment from non-selected segments comprises distinguishing the selected segment from non-selected segments using any one or more of symbol overlays, region highlighting, region coloring, region grey-scaling, region border highlighting, region border coloring, region border grey-scaling, and region border line widths.

16. The method of claim 1, further comprising:
facilitating selection of a link presented via the visually enhanced view of the selected segment in the second portion of the display;
creating a second raster image of second content resulting from selection of the link;
dividing the second raster image of the second content into a plurality of second segments to create a second segmented image;
presenting the second segmented image of the second content in the first portion of the display;
facilitating selection of at least one resulting segment of the second segmented image; and
presenting a visually enhanced view of the selected resulting segment in the second portion of the display.

17. The method of claim 16, wherein presenting the second segmented image in the first portion of the display comprises replacing the segmented image of the content in the first portion of the display with the second segmented image of the second content in the first portion of the display.

18. The method of claim 1, wherein the content comprises at least one page of information received at the communication device via a network.

19. The method of claim 1, wherein dividing the raster image of the content into a plurality of segments to create a segmented image comprises receiving user input substantially identifying boundaries of at least one of the plurality of segments.

20. The method of claim 1, further comprising presenting an adjacent segment in the second portion of the display when the selected segment has been scrolled beyond its border in the second portion of the display, wherein the adjacent segment represents the segment in the segmented image that borders the selected segment in a direction of scrolling.

21. The method of claim 1, wherein the selected segment presented in the second portion of the display changes in response to a triggering event, and further comprising automatically generating an updated raster image and demarcating a region corresponding to the change in the selected segment presented in the second portion of the display.

22. The method of claim 1, wherein presenting the segmented image of the content in a first portion of the display comprises presenting indicia on the segmented image in place of at least some characters associated with an original version of the content.

23. The method of claim 22, wherein the indicia has display characteristics including one or both of a shape and a color.

24. A method for presenting content on a display of a communication device, comprising:
presenting a raster image of the content in a first portion of the display;
presenting a visually enhanced view of a section of the raster image in a second portion of the display;
demarcating, on the raster image in the first portion of the display, the section of the raster image that is presented in the second portion of the display; and
updating the demarcation on the raster image in the first portion of the display as the section is moved within the second portion of the display.

25. The method of claim 24, further comprising facilitating user designation of a location on the raster image in the first portion of the display, and presenting the section corresponding to the designated location in the second portion of the display.

26. A communication device, comprising:
a display;
a transceiver to transmit requests for content available on a network and to receive the content in response thereto; and
a processor configured to present a segmented raster image of the content in a first area of the display, to recognize at least one selected segment from the segmented raster image, and to present a visually enhanced view of the at least one selected segment in a second area of the display.

27. The communication device as in claim 26, wherein the content is received via the transceiver as a raster image, and wherein the processor is further configured to divide the raster image into a plurality of segments to create the segmented raster image.

28. The communication device as in claim 26, wherein the processor is further configured to generate a raster image of the content, and to divide the raster image into a plurality of segments to create the segmented raster image.

29. The communication device as in claim 26, further comprising a narrow-screen formatting module operable via the processor and configuring the processor to present the at least one selected segment in a narrow-screen layout in the second area of the display.

30. The communication device as in claim 26, further comprising a user interface to facilitate user selection of the at least one selected segment.

31. The communication device as in claim 26, wherein the processor is further configured to automatically select the at least one selected segment from the segmented raster image based on at least one predetermined criterion.

32. The communication device as in claim 31, wherein the at least one predetermined criterion comprises at least one of a segment presentation location and a segment category.

33. The communication device as in claim 26, wherein the transceiver comprises a wireless transceiver capable of communicating over-the-air (OTA) with a wireless network.

34. The communication device as in claim 26, wherein the transceiver comprises a modem capable of communicating with a data network.

35. The communication device as in claim 26, wherein the communication device comprises any of a mobile phone, Personal Digital Assistant (PDA), a portable computer, and a desktop computer.

36. A system for presenting content on a display of a communication device, comprising:
a network element comprising a first processor configured to generate a raster image of requested content, and to divide the raster image into a plurality of segments to create the segmented raster image; and
a communication device coupled to the network element over a network, the communication device comprising:
a display;
a transceiver to transmit requests for the requested content and to receive the segmented raster image from the network element; and
a second processor configured to present the segmented raster image in a first area of the display, to recognize at least one selected segment from the segmented raster image, and to present a visually enhanced view of the at least one selected segment in a second area of the display.

37. A computer-readable medium having instructions stored thereon which are executable by a computer system for presenting content on a display of a communication device by performing steps comprising:
dividing a raster image of the content into a plurality of segments to create a segmented image;
presenting the segmented image of the content in a first portion of the display;
facilitating selection of at least one segment of the segmented image; and
presenting a visually enhanced view of the selected segment in a second portion of the display.

38. A method for presenting content on a display of a communication device, the method comprising:
presenting a segmented raster image of the content on the display, wherein the segmented raster image includes a plurality of segments;
respectively correlating unique labels with at least some of the plurality of segments;
presenting each of the unique labels together with its associated one of the segments;
recognizing user input of at least one of the unique labels;
identifying the segment associated with the unique label input by the user; and
presenting a visually enhanced view of the identified segment on the display.

39. The method of claim 38, wherein presenting each of the unique labels together with its associated one of the segments comprises continuously presenting each of the unique labels together with its associated one of the segments.

40. The method of claim 38, wherein presenting each of the unique labels together with its associated one of the segments comprises superimposing each of the unique labels on its associated one of the segments.

41. The method of claim 40, wherein superimposing each of the unique labels on its associated one of the segments comprises displaying each of the unique labels on its associated one of the segments using alpha-blending.

42. The method of claim 38, wherein presenting each of the unique labels together with its associated one of the segments comprises temporarily presenting each of the unique labels together with its associated one of the segments.

43. The method of claim 38, wherein presenting each of the unique labels together with its associated one of the segments comprises presenting each of the unique labels together with its associated one of the segments upon user command.

44. The method of claim 38, wherein presenting each of the unique labels together with its associated one of the segments comprises temporarily displaying each of the unique labels together with its associated one of the segments using hot-toggling.

45. The method of claim 38, wherein the identified segment includes a plurality of subsegments that are hierarchical descendants of the identified segment, and wherein the method further comprises:
(a) respectively correlating second unique labels with at least some of the plurality of subsegments;
(b) presenting each of the second unique labels together with its associated one of the subsegments;
(c) recognizing user input of at least one of the second unique labels;
(d) identifying the subsegment associated with the second unique label input by the user;
(e) presenting a visually enhanced view of the identified subsegment on the display.

46. The method of claim 45, further comprising repeating steps (a)-(e) for each of the identified subsegments having hierarchical descendants of the respective identified subsegment, until a resulting identified subsegment has no hierarchical descendants.

47. The method of claim 45, further comprising repeating steps (a)-(e) for each of the identified subsegments having hierarchical descendants of the respective identified subsegment, until the user discontinues hierarchical labeling via a user interface.

48. The method of claim 38, further comprising:
creating a raster image of the content; and
dividing the raster image into the plurality of segments to produce the segmented raster image.

49. The method of claim 38, wherein presenting a visually enhanced view of the identified segment on the display comprises formatting the identified segment to fit a display width of the display.

50. The method of claim 49, wherein formatting the identified segment to fit a display width comprises generating a zoomed-in version of the identified segment and adjusting the zoomed-in version of the identified segment to fit the display width of the display.

51. A communication device, comprising:
a display;
a user interface;
a transceiver to transmit requests for content available on a network and to receive the content in response thereto; and
a processor configured to present a segmented raster image of the content via the display, respectively correlate unique labels with each of a plurality of segments associated with the segmented raster image, present each of the unique labels together with its associated one of the segments, recognize user input of at least one of the unique labels via the user interface, identify the segment associated with the unique label input by the user, and present a visually enhanced view of the identified segment on the display.

52. The communication device as in claim 51, wherein the content is received via the transceiver as a raster image, and wherein the processor is further configured to divide the raster image into the plurality of segments to create the segmented raster image.

53. The communication device as in claim 51, wherein the processor is further configured to generate a raster image of the content, and to divide the raster image into the plurality of segments to create the segmented raster image.

54. The communication device as in claim 51, further comprising a narrow-screen formatting module operable via the processor and configuring the processor to present identified segment in a narrow-screen layout on the display.

55. The communication device as in claim 51, wherein the transceiver comprises a wireless transceiver capable of communicating over-the-air (OTA) with a wireless network.

56. The communication device as in claim 51, wherein the transceiver comprises a modem capable of communicating with a data network.

57. The communication device as in claim 51, wherein the communication device comprises any of a mobile phone, Personal Digital Assistant (PDA), a portable computer, and a desktop computer.

58. A computer-readable medium having instructions stored thereon which are executable by a computer system for presenting content on a display of a communication device by performing steps comprising:
presenting a segmented raster image of the content on the display, wherein the segmented raster image includes a plurality of segments;
respectively correlating unique labels with at least some of the plurality of segments;
presenting each of the unique labels together with its associated one of the segments;
recognizing user input of at least one of the unique labels;
identifying the segment associated with the unique label input by the user; and
presenting a visually enhanced view of the identified segment on the display.

59. A method for preparing content for viewing on a communication device display, comprising:
presenting a raster image of the content on the communication device display;
facilitating user demarcation of one or more regions on the raster image; and
segmenting the raster image into a plurality of segments, wherein one or more of the plurality of segments substantially correspond to the one or more regions demarcated by the user.

60. The method of claim 59, further comprising presenting at least one of the segments that substantially corresponds to the one or more user-demarcated regions on the communication device display.

61. The method of claim 60, wherein presenting at least one of the segments that substantially corresponds to the one or more user-demarcated regions comprises presenting the segments in a narrow-screen layout on the communication device display.

62. The method of claim 60, wherein presenting at least one of the segments that substantially corresponds to the one or more user-demarcated regions comprises independently presenting each of the segments in a vertical contiguous arrangement.

63. The method of claim 60, wherein presenting at least one of the segments that substantially corresponds to the one or more user-demarcated regions comprises presenting all of the plurality of segments, including the one or more segments that substantially correspond to the one or more user-demarcated regions, on the communication device display.

64. The method of claim 60, wherein presenting at least one of the segments that substantially corresponds to the one or more user-demarcated regions comprises presenting on the communication device display only the one or more segments that substantially correspond to the one or more user-demarcated regions.

65. The method of claim 60, further comprising facilitating user selection of one or more of the plurality of segments to be presented on the communication device display.

66. The method of claim 59, further comprising:
recognizing user input identifying one or more of the plurality of segments for viewing; and
presenting the identified one or more of the plurality of segments on the device display.

67. The method of claim 66, further comprising respectively correlating a link with each of the plurality of segments, and wherein recognizing user input identifying one or more of the plurality of segments for viewing comprises recognizing user selection of one or more of the links corresponding to the identified one or more of the plurality of segments.

68. The method of claim 59, wherein facilitating user demarcation of one or more regions on the raster image comprises providing a user interface facilitating visual demarcation of the one or more regions on the raster image.

69. The method of claim 59, wherein facilitating user demarcation of one or more regions on the raster image comprises a step for facilitating visual demarcation of the one or more regions on the raster image.

70. The method of claim 59, wherein facilitating user demarcation of one or more regions on the raster image comprises:
enabling the user to demarcate multiple regions on the raster image; and
recognizing user input to discontinue further user demarcation of the regions.

71. The method of claim 59, further comprising determining a nearest probable segment boundary for each of the one or more regions demarcated by the user, and adjusting the one or more regions demarcated by the user to coincide with their respective nearest probable segment boundary in connection with the segmenting of the raster image.

72. The method of claim 59, further comprising snapping each of the one or more regions demarcated by the user to its respective most plausible segment boundary.

73. The method of claim 59, wherein the content comprises at least one network-accessible web page.

74. The method of claim 59,
(a) further comprising:
(i) associating previous user-demarcated regions with their corresponding content addresses;
(ii) storing the association of the previous user-demarcated regions and the corresponding content addresses;
(iii) comparing a currently-received content address with the stored content addresses; and
(b) wherein segmenting the raster image into a plurality of segments comprises segmenting the raster image of the currently-received content using the stored user-demarcated regions associated with the content address.

75. A communication device, comprising:
a display;
a user interface;
a transceiver to transmit requests for content available on a network and to receive the content in response thereto; and
a processor configured to present a raster image of the content on the communication device display, recognize user input identifying one or more regions on the raster image, and divide the raster image into a plurality of segments, wherein at least one of the plurality of segments substantially corresponds to the one or more regions identified by the user.

76. The communication device as in claim 75, wherein the processor is further configured to present at least one of the segments that substantially corresponds to the one or more user-identified regions on the display.

77. The communication device as in claim 75, wherein the transceiver comprises a wireless transceiver capable of communicating over-the-air (OTA) with a wireless network.

78. The communication device as in claim 75, wherein the transceiver comprises a modem capable of communicating with a data network.

79. The communication device as in claim 75, wherein the communication device comprises any of a mobile phone, Personal Digital Assistant (PDA), a portable computer, and a desktop computer.

80. A system for preparing content for viewing, comprising:
(a) a network element comprising a first processor configured to generate a raster image of requested content;
(b) a communication device, including:
(i) a display;
(ii) a user interface;
(iii) a transceiver to transmit requests for content available on a network and to receive the content in response thereto;
(iv) a second processor configured to present the raster image of the content on the communication device display and recognize user input identifying one or more regions on the raster image; and
(c) wherein the first processor of the network element is further configured to segment the raster image into a plurality of segments, wherein at least one of the plurality of segments substantially corresponds to the one or more regions identified by the user input.

81. The system as in claim 80, wherein the transceiver of the communication device is configured to receive the segmented raster image over the network from the network element.

82. The system as in claim 81, wherein the second processor of the communication device is further configured to present at least one of the segments that substantially corresponds to the one or more regions identified by the user input.

83. A computer-readable medium having instructions stored thereon which are executable by a computer system for preparing content for viewing on a communication device display by performing steps comprising:
presenting a raster image of the content on the communication device display;
facilitating user demarcation of one or more regions on the raster image; and
segmenting the raster image into a plurality of segments, wherein one or more of the plurality of segments substantially correspond to the one or more regions demarcated by the user.
